(19) United States
(12) Patent Application Publication
(10) Pub. No.: US 2022/0005092 A1
(43) Pub. Date: Jan. 6, 2022

(54) ONLINE SOFTWARE PLATFORM (OSP) GENERATING RECOMMENDATION OF POSSIBLE DIFFERENT PRODUCTION OF RESOURCES FOR IMPENDING RELATIONSHIP INSTANCE

(71) Applicant: Avalara, Inc., Seattle, WA (US)

(72) Inventors: Naveen Kumar Agrawal, Bellevue, WA (US); Paul R. Sanford, II, Lake Forest Park, WA (US)

(21) Appl. No.: 17/365,332

(22) Filed: Jul. 1, 2021

Related U.S. Application Data
(60) Provisional application No. 63/047,849, filed on Jul. 2, 2020.

(51) Int. Cl. G06Q 30/04; G06Q 20/20; G06F 40/205

(52) U.S. Cl. CPC G06Q 30/04; G06F 40/205; G06Q 20/207

(57) ABSTRACT

An online software platform (OSP) may look up one or more alignment digital rules that determine exemptibility of a relationship instance; apply the one or more alignment digital rules to the relationship instance based on one or more attributes of the relationship instance; determine the exemptibility of the relationship instance based on the application of the one or more alignment digital rules to the relationship instance; and transmit a notification regarding the exemptibility of the relationship instance, thus helping to prevent unnecessary or incorrect production of resources by automated systems.

### TECHNICAL FIELD

The technical field relates to computers in networks, and particularly to networked automated systems for generating recommendation of possible different production of resources for an impending relationship instance.

### BRIEF SUMMARY

The present description gives instances of computer systems, devices and storage media that may store programs and methods.

An online service platform (OSP) can be configured to perform one or more predefined services. Such services may include producing respective resources for relationship instances between primary entities and secondary entities by applying digital rules to respective datasets from primary entities that represent the relationship instances. However, some relationship instances may be exempt from a requirement to remit a non-zero resource associated with the relationship instance and the respective primary entities and secondary entities of those relationship instances may not be aware of such exemptibility, which would cause unnecessary or incorrect production of resources.

Thus, to solve the above technical problems, embodiments of the present disclosure include functionality that enables the OSP to look up one or more alignment digital rules that determine exemptibility of the relationship instance; apply the one or more alignment digital rules to the relationship instance based on one or more attributes of the relationship instance; determine the exemptibility of the relationship instance based on the application of the one or more alignment digital rules to the relationship instance; and transmit a notification regarding the exemptibility of the relationship instance, thus helping to prevent unnecessary or incorrect production of resources for exempt relationship instances.

Therefore, the systems and methods described herein for generating a recommendation of possible different production of resources for an impending relationship instance improve the functioning of computer or other hardware, such as by reducing the processing, storage, and/or data transmission resources needed to perform various tasks, thereby enabling the tasks to be performed by less capable, capacious, and/or expensive hardware devices, enabling the tasks to be performed with less latency and/or preserving more of the conserved resources for use in performing other tasks or additional instances of the same task.

As shown above and in more detail throughout the present disclosure, the present disclosure provides technical improvements in computer networks and to existing computerized systems that facilitate estimation of resources.

These and other features and advantages of the claimed invention will become more readily apparent in view of the embodiments described and illustrated in this specification, namely in this written specification and the associated drawings.

### BRIEF DESCRIPTION OF THE SEVERAL VIEWS OF THE DRAWINGS

The components in the drawings are not necessarily drawn to scale relative to each other. Like reference numerals designate corresponding parts throughout the several views.

FIG. 1 is a diagram showing sample aspects of embodiments of the present disclosure involving generating and transmitting a notification regarding the exemptibility of a relationship instance, according to embodiments of the present disclosure, which is an improvement in automated computerized systems.

FIG. 2 is a diagram that repeats some of the digital main rules of FIG. 1 in more detail, and juxtaposes them with a flowchart portion for a sample method of how it may be recognized that conditions of a certain digital main rule can be met for its consequent to be applied, all according to embodiments of the present disclosure, which is an improvement in automated computerized systems.

FIG. 3 is a flowchart for illustrating a sample method for transmitting a notification regarding the exemptibility of a relationship instance determined based on applying one or more alignment digital rules to the relationship instance, according to embodiments of the present disclosure, which is an improvement in automated computerized systems.

FIG. 4 is a flowchart for illustrating a sample method for applying one or more alignment digital rules to a relationship instance that is useful in the method of FIG. 3, according to embodiments of the present disclosure, which is an improvement in automated computerized systems.

FIG. 5 is a flowchart for illustrating a sample method for presenting selectable options for initiating determination of the exemptibility of future relationship instances that is useful in the method of FIG. 3, according to embodiments of the present disclosure, which is an improvement in automated computerized systems.

FIG. 6 is a flowchart for illustrating a sample method for transmitting a notification regarding a non-zero resource in conjunction with a notification regarding the exemptibility of the relationship instance that is useful in the method of FIG. 3, according to embodiments of the present disclosure, which is an improvement in automated computerized systems.

FIG. 7 is a flowchart for illustrating another sample method for applying one or more alignment digital rules to a relationship instance that is useful in the method of FIG. 3, according to embodiments of the present disclosure, which is an improvement in automated computerized systems.

FIG. 8 is a flowchart for illustrating a sample method for using looked-up data regarding a secondary entity to initiate a workflow to obtain exemption documents regarding the secondary entity that is useful in the method of FIG. 3, according to embodiments of the present disclosure, which is an improvement in automated computerized systems.

FIG. 9 is a block diagram illustrating components of an exemplary computer system according to some exemplary embodiments, which may read instructions from a machine-readable medium (e.g., a non-transitory computer-readable medium) and perform any one or more of the processes, methods, and/or functionality discussed herein, according to embodiments of the present disclosure, which is an improvement in automated computerized systems.

FIG. 10 is a diagram of sample aspects for describing operational examples and use cases of embodiments, according to embodiments of the present disclosure, which is an improvement in automated computerized systems.

FIG. 11 is a block diagram showing entities and example interaction between such entities according to an example use case of an embodiment of the present disclosure, which is an improvement in automated computerized systems.

FIG. 12 is a sample view of a User Interface (UI) in which a notification is presented to a primary entity regarding the exemptibility of a relationship instance according to an example use case of an embodiment of the present disclosure, which is an improvement in automated computerized systems.

FIG. 13 is a sample view of a User Interface (UI) in which a notification is presented to a secondary entity regarding the exemptibility of a relationship instance according to an example use case of an embodiment of the present disclosure, which is an improvement in automated computerized systems.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, that embodiments of the inventive subject matter may be practiced without these specific details. In general, well-known structures and methods associated with underlying technology have not been shown or described in detail to avoid unnecessarily obscuring descriptions of the preferred embodiments.

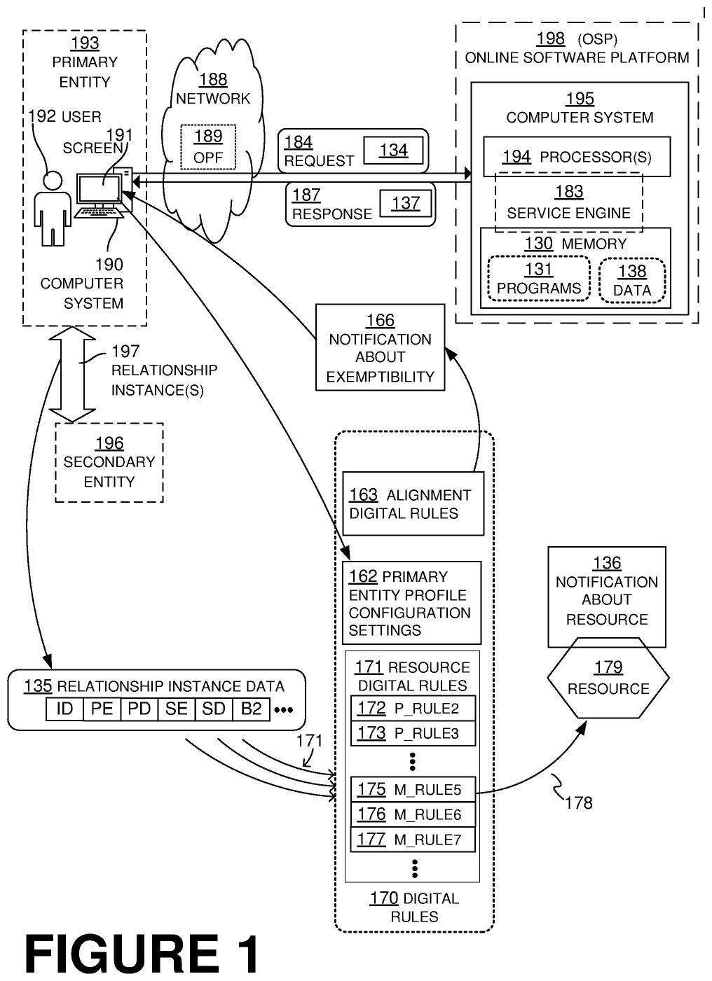

FIG. 1 is a diagram showing sample aspects of embodiments of the present disclosure involving generating and transmitting a notification regarding the exemptibility of a relationship instance, according to embodiments of the present disclosure, which is an improvement in automated computerized systems.

A sample computer system 195, network 188, primary entity computer system 190 and secondary entity 196 according to embodiments is shown. The computer system 195 has one or more processors 194 and a memory 130. The memory 130 stores programs 131 and data 138. The one or more processors 194 and the memory 130 of the computer system 195 thus implement a service engine 183. Additional implementation details for the computer system 195 are given later in this document.

The computer system 195 can be located in “the cloud.” In fact, the computer system 195 may optionally be implemented as part of an online software platform (OSP) 198. The OSP 198 can be configured to perform one or more predefined services, for example, via operations of the service engine 183. Such services can be, but are not limited to: receiving a dataset 135 on behalf of the primary entity 193, in which the dataset 135 includes data regarding a relationship instance 197 between the primary entity 193 and a secondary entity 196; looking up one or more alignment digital rules 163 that determine exemptibility of the relationship instance 197 (in which the exemptibility indicates whether or not the relationship instance is exempt from a requirement to remit a non-zero resource 179 associated with the relationship instance 197); applying the one or more alignment digital rules 163 to the relationship instance 197 based on one or more attributes of the relationship instance 197; determining the exemptibility of the relationship instance 197 based on the application of the one or more alignment digital rules 163 to the relationship instance; transmitting a notification 166 regarding the exemptibility of the relationship instance; and so on, including what is described in this document. Such services can be provided as a Software as a Service (SaaS).

A user 192 may be standalone. The user 192 may use a computer system 190 that has a screen 191, on which User Interfaces (UIs) may be shown. Additional sample implementation details for the computer system 190 are given later in this document. In embodiments, the user 192 and the computer system 190 are considered part of a primary entity, such as primary entity 193, which can be referred to also merely as an entity or a client of OSP 198. In such instances, the user 192 can be an agent of the entity 193, and even within a physical site of the entity 193, although that is not necessary. In embodiments, the computer system 190 or other device of the user 192 or the entity 193 are primary entity devices for the computer system 195.

The computer system 190 may access the computer system 195 via a communication network 188, such as the internet. In particular, the entities and associated systems of FIG. 1 may communicate via physical and logical channels of the communication network 188. For example, information may be communicated as data using the Internet Protocol (IP) suite over a packet-switched network such as the Internet or other packet-switched network, which may be included as part of the communication network 188. The communication network 188 may include many different types of computer networks and communication media including those utilized by various different physical and logical channels of communication, now known or later developed. Non-limiting media and communication channel examples include one or more, or any operable combination of: fiber optic systems, satellite systems, cable systems, microwave systems, asynchronous transfer mode (“ATM”) systems, frame relay systems, digital subscriber line (“DSL”) systems, radio frequency (“RF”) systems, telephone systems, cellular systems, other wireless systems, and the Internet. In various embodiments the communication network 188 can be or include any type of network, such as a local area network (LAN), a metropolitan area network (MAN), a wide area network (WAN), or the internet.

Downloading or uploading may be permitted from one of these two computer systems to the other, and so on. Such accessing can be performed, for instance, with manually uploading files, like spreadsheet files, etc. Such accessing can also be performed automatically as shown in the example of FIG. 1. The computer system 190 and the computer system 195 may exchange requests and responses with each other. Such can be implemented with a number of architectures.

In one such architecture, a device remote to the service engine 183, such as computer system 190, may have a certain application (not shown) and a connector (not shown) that is a plugin that sits on top of that certain application. The connector may be able to fetch from the remote device the details required for the service desired from the OSP 198, form an object or payload 134, and then send or push a request 184 that carries the payload 134 to the service engine 183 via a service call. The service engine 183 may receive the request 184 with the payload 134.

The request 184 may also include particular option selections regarding the one or more predefined services that the OSP 198 can be configured to perform, such as options regarding transmitting and/or receiving notifications, such as notification 166, regarding the exemptibility of past, impending or future relationship instances, such as relationship instances 197. Such a notification 166 may be received in response to a determination by the OSP 198 that the relationship instance 197 is or may be exemptible based on the application of one or more alignment digital rules 163 to the relationship instance 197. For example, the service engine 183 may receive a dataset 135 on behalf of the primary entity 193, in which the dataset 135 includes data regarding a relationship instance 197 between the primary entity 193 and a secondary entity 196. The service engine 183 may look up one or more alignment digital rules 163 that determine exemptibility of the relationship instance 197. In an example embodiment, the exemptibility indicates whether or not the relationship instance is exempt from a requirement to remit a non-zero resource 179 associated with the relationship instance 197. The service engine 183 may then apply the one or more alignment digital rules 163 to the relationship instance 197 based on one or more attributes of the relationship instance 197; determine the exemptibility of the relationship instance 197 based on the application of the one or more alignment digital rules 163 to the relationship instance; and transmit a notification 166 regarding the exemptibility of the relationship instance. In some embodiments, the primary entity 193 may have pre-set preferences stored in the primary entity profile configuration settings 162 indicating whether the primary entity 193 would like to receive such notifications regarding exemptibility and how such notifications should be handled, such as by optionally transmitting such a notification about exemptibility 166 instead or also to the secondary entity 166 associated with the relationship instance 197.

In some embodiments, the relationship instance 197 is an impending relationship instance and the service engine 183 also looks up one or more resource digital rules 171 for producing the non-zero resource 179 associated with the relationship instance 197; applies the one or more resource digital rules 171 to the relationship instance based on one or more attributes of the relationship instance 197; produces the non-zero resource 179 associated with the relationship instance 197 based on the application of the one or more resource digital rules 171 to the relationship instance 197; and transmits a notification 136 regarding the non-zero resource 179 in conjunction with the notification 166 regarding the exemptibility of the relationship instance 197.

The service engine 183 may form a payload 137 that is an aspect of the resource 179 and/or the exemptibility of the relationship instance 197, and then push, send, or otherwise cause to be transmitted a response 187 that carries the payload 137 to the connector. The connector reads the response 187 and forwards the payload 137 to the certain application. Thus, the response 187 may be, or may include, the notification about exemptibility 166 and/or the notification about the resource 136. In some embodiments, the exemptibility of the relationship instance 197 indicates that the relationship instance 197 has the potential or possibility to be exempt from a requirement to remit the resource 179 associated with the relationship instance 197, but further action is to be taken by, or further documentation or validation is to be received from, the primary entity 193 or secondary entity 196 for the relationship instance 197 to actually be exempt from a requirement to remit the resource 179 associated with the relationship instance 197.

In some embodiments, the OSP 198 may generate and deliver a software development kit (SDK) (not shown) including libraries, documentation, code samples, processes, and guides that the primary entity 193 can use and integrate with the connector and other applications of the computer system 190 to implement functionality described herein. The SDK may be a collection of software development tools in one package installable by the primary entity computer system 190. The SDK may facilitate the creation of applications by having a compiler, debugger and a software framework. The SDK may include libraries, documentation, code samples, processes, and guides that the primary entity 193 can use and integrate with the connector and other applications of the computer system 190 to implement the functionality described herein. In various embodiments, the connector may have been built by the primary entity 193, the OSP 198 or another entity. The primary entity 193 may use the SDK for controlling the developing and adjusting, from the primary entity-side, operations of the connector.

In an alternative such architecture, a device remote to the service engine 183, such as computer system 190, may have a particular application (not shown). In addition, the computer system 195 may implement a REST (Representational State Transfer) API (Application Programming Interface) (not shown). REST or RESTful API design is designed to take advantage of existing protocols. While REST can be used over nearly any protocol, it usually takes advantage of HTTP (Hyper Text Transfer Protocol) when used for Web APIs. This alternative architecture enables the primary entity 193 to directly consume a REST API from their particular application, without using a connector. The particular application of the remote device may be able to fetch internally from the remote device the details required for the service desired from the OSP 198, and thus send or push the request 184 to the REST API. In turn, the REST API talks in background to the service engine 183. Again, the service engine 183 determines the requested resource 179, and sends an aspect of it back to the REST API. In turn, the REST API sends the response 187 that has the payload 137 to the particular application. In some embodiments, the response 137 may include the notification 166 instead of or along with the requested resource 179. Also, in some embodiments, the notification 136 about the resource 179 may include the notification 166 instead of or along with the requested resource 179.

Moreover, in some embodiments, data from the computer system 190 and/or from the computer system 195 may be stored in an Online Processing Facility (OPF) 189 that can run software applications, perform operations, and so on. In such embodiments, requests and responses may be exchanged with the OPF 189, downloading or uploading may involve the OPF 189, and so on. In such embodiments, the computer system 190 and any devices of the OPF 189 can be considered to be remote devices, at least from the perspective of the computer system 195.

In some instances, the user 192 or the primary entity 193 may have instances of relationships with secondary entities. Only one such secondary entity 196 is shown. However, additional secondary entities may be present in various other embodiments. For example, the primary entity 193 may have a relationship instance 197 with the secondary entity 196 via an intermediary entity (not shown).

In some instances, the user 192 and the primary entity 193 may have data about one or more secondary entities, for example, via relationship instances of the user 192 or primary entity with the secondary entity 196. The primary entity 193, an intermediary entity and/or the secondary entity 196 may be referred to as simply entities. One of these entities may have one or more attributes. Such an attribute of such an entity may be any one of its name, type of entity, a physical or geographical location such as an address, a contact information element, an affiliation, a characterization of another entity, a characterization by another entity, an association or relationship with another entity (general or specific instances), an asset of the entity, a declaration by or on behalf of the entity, and so on.

In embodiments, the computer system 190 generates one or more datasets. A sample generated dataset 135 is shown. The dataset 135 has values that can be numerical, alphanumeric, Boolean, and so on, as needed for what the values characterize. For example, an identity value ID may indicate an identity of the dataset 135, so as to differentiate it from other such datasets. At least one of the values of the dataset 135 may characterize an attribute of a certain one of the entities 193 and 196. Accordingly, in this example the sample received dataset 135 has a value ID for an identity of the dataset 1035 and/or the relationship instance 197. The dataset 135 also has a value PE for the name of the primary entity 193 or the user 192. The dataset 135 further has a value PD for relevant data of the primary entity 193, the user 192, or the relationship instance. The dataset 135 also has a value SE for the name of the secondary entity 196. The dataset 135 further has a value SD for relevant data of the secondary entity 196. Plus, an optional value B2 may be a numerical base value for an aspect of the dataset, and so on. The aspect of the dataset may be a numerical value associated with the relationship 197 or an item that is the subject of the relationship instance 197 or the dataset 135. The value B2 may represent an aspect of the value that characterizes the attribute, an aspect of the reason that the dataset 135 was created in the first place, an indication of an identity or other characteristic of the primary entity 193 and/or the secondary entity 196, etc. The dataset 135 may further have additional such values, as indicated by the horizontal dot-dot-dot to the right of the dataset 135. In some embodiments, the dataset 135 has values that characterize additional attributes of each of the primary entity 193 and the secondary entity 196, but that is not required.

In embodiments, stored digital rules 170 may be accessed by the computer system 195. These rules 170 are digital in that they are implemented for use by software. For example, these rules 170 may be implemented within programs 131 and data 138. The data portion of these rules 170 may alternately be implemented in memories in other places, which can be accessed via the network 188. These digital rules 170 may be accessed responsive to receiving a dataset, such as the dataset 135.

The digital rules 170 may include main rules, which can thus be accessed by the computer system 195. In this example, three sample digital main rules are shown explicitly, namely M_RULE5 175, M_RULE6 176, and M_RULE7 177. In this example, the digital rules 170 also include digital precedence rules P_RULE2 172 and P_RULE3 173, which can thus be further accessed by the computer system 195. The digital rules 170 may include additional rules and types of rules, as suggested by the vertical dot-dot-dots.

In embodiments, a certain one of the digital main rules may be identified from among the accessed stored rules by the computer system 195. In particular, values of the dataset 135 can be tested, according to arrows 171, against logical conditions of the digital main rules, as described later in this document. In an example embodiment, one or more alignment digital rules 163 may be stored that indicate requirements relationship instances, such as relationship instance 197, must meet to be exempt from a requirement to remit a non-zero resource associated with the relationship instance. For example, such requirements may be based on one or more attributes of the relationship instance 197, including, but not limited to: attributes of the primary entity 193, attributes of the secondary entity 196, and attributes of an item that is the subject of the relationship instance 197. Such attributes may be looked up by the service engine 183 from the dataset 135 representing the relationship instance 197 and/or other sources, including those local or remote from the computer system 195 of the OSP 198. Thus, values of the dataset 135 and/or other values regarding the relationship instance 197 looked up by the service engine 183 can also be tested against logical conditions of the alignment digital rules. In this example, the certain main rule M_RULE5 175 is identified, which is indicated also by the beginning of an arrow 178 that is described in more detail later in this document. Identifying may be performed in a number of ways depending on how the digital main rules are implemented. An example is now described.

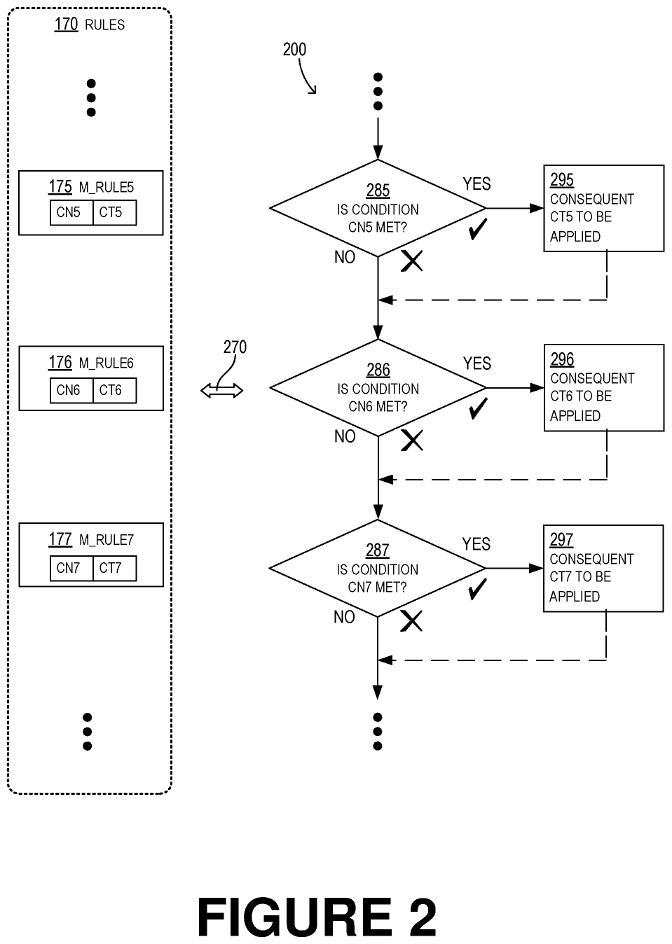

Referring now also to FIG. 2, some of the digital main rules of digital rules 170 are repeated from FIG. 1 in more detail. In addition, according to an arrow 270, these digital main rules are shown juxtaposed with a flowchart portion 200. In embodiments, some of the digital main rules can be expressed in the form of a logical “if-then” statement, such as: “if P then Q”. In such statements, the “if” part, represented by the “P”, is called the condition, and the “then” part, represented by the “Q”, is called the consequent. Therefore, at least some of the digital main rules include respective conditions and respective consequents associated with the respective conditions, respectively. And, for a certain digital main rule, if its certain condition P is met, then its certain consequent Q is what happens or becomes applied. Of course, one or more of the digital rules 170 may have more than one conditions P that both must be met, and so on. And some of these digital rules 170 may be searched for, and grouped, according first to one of the conditions, and then the other. In this example, the digital main rules M_RULE5 175, M_RULE6 176, and M_RULE7 177 of FIG. 1, include respective conditions CN5, CN6, CN7, and respective consequents CT5, CT6, CT7 associated with the respective conditions CN5, CN6, CN7, respectively.

In embodiments, therefore, identifying is performed by recognizing, by the computer system 195, that a certain condition of a certain one of the accessed digital main rules is met by one or more of the values of the dataset. An example of the operations of recognizing that a condition is met and thus identifying an applicable rule is shown by flowchart portion 200 of FIG. 2. According to successive decision diamonds 285, 286, 287, it is determined whether or not conditions CN5, CN6, CN7 are met by at least one of the values of the dataset, respectively. If the answer is NO, then execution may proceed to the next diamond. If the answer is YES then, according to operations 295, 296, 297, it is further determined that the respective consequents CT5, CT6, CT7 are to be applied, and then execution may proceed to the next diamond in the flowchart portion. A consequent that is to be applied could be, for example, flagged as TRUE.

From what was mentioned in connection with FIG. 1, the certain M_RULE5 175 was thus identified. With reference to FIG. 2, the identification may have happened at operation 285 of the flowchart portion 200, at which time it was recognized that condition CN5 was met by a value of the dataset 135. This made: the condition CN5 be the certain condition, the digital main rule M_RULE5 175 be the certain digital main rule, and the consequent CT5 be the certain consequent of the certain digital main rule M_RULE5 175. And the certain consequent CT5 is associated with the certain condition CN5, since both are included by the certain digital main rule M_RULE5 175. Therefore, according to operation 295, consequent CT5 is what happens or becomes applied, as described below.

A number of examples are possible for how to recognize that a certain condition of a certain digital rule is met by at least one of the values of the dataset. For instance, the certain condition could define a boundary of a region that is within a space. The region could be geometric, and even be within a larger space and may include political boundaries. For example, the region could be geographic, within the space of a city, a county, a state, a country, a continent or the earth. The boundary of the region could be defined in terms of numbers according to a coordinate system within the space. In the example of geography, the boundary could be defined in terms of groups of longitude and latitude coordinates. In such embodiments, the certain condition could be met responsive to the characterized attribute of the dataset being in the space and within the boundary of the region instead of outside the boundary. For instance, the attribute could be a location of the entity, and the one or more values of the dataset 135 that characterize the location could be one or more numbers or an address, or longitude and latitude. The condition can be met depending on how the one or more values compare with the boundary. For example, the comparison may reveal that the location is in the region instead of outside the region. The comparison can be made by rendering the characterized attribute in units comparable to those of the boundary. For example, the characterized attribute could be an address that is rendered into longitude and latitude coordinates, and so on.

In an example embodiment, the certain condition could define a threshold that needs to be crossed for an activity to be started or stopped. In such embodiments, the certain condition could be met responsive to a value based on one or more of the characterized attributes of one or more datasets, either individually or in aggregate, crossing the threshold.

The above embodiments are only examples, and not limiting. For instance, the example of FIG. 2 suggests that there is a one-to-one correspondence of the conditions with the associated consequents, but that is not necessary. In fact, a single consequent may be associated with two or more conditions, and two or more consequents may be associated with a single condition. Of course, all such can be shown as additional rules, with groups of them having the same condition or consequent.

For another instance, once it is determined that a consequent is to be applied, execution may even exit the flowchart portion 200. Or, as shown, it may be determined that more than one of the digital main rules is to be applied. In particular, operation 285 may give the answer YES such that consequent CT5 is to be applied, and operation 286 may also give the answer YES such that consequent CT6 is to be applied.

Where more than one of the digital main rules are found that could be applied, there are additional possibilities. For instance, the computer system 195 of FIG. 1 may further access at least one stored digital precedence rule, such as P_RULE2 172 or P_RULE3 173. Accordingly, the certain digital main rule may be thus identified also from the digital precedence rule. In particular, the digital precedence rule may decide which one or more of the digital main rules is to be applied. To continue the previous example, if a value of the dataset 135 that characterizes a location, and the location is within multiple overlapping regions according to multiple rules, the digital precedence rule may decide that all of them are to be applied, or less than all of them are to be applied. Equivalent embodiments are also possible, where digital precedence rules are applied first to limit the iterative search of the flowchart portion 200, so as to test the applicability of fewer than all the rules according to arrows 171.

In embodiments, a resource may be produced for the dataset 135, and/or other activities may be performed, by the computer system 195 applying the certain consequent of the certain digital main rule. The resource can be a computational result, a document, an item of value, a representation of an item of value, etc., made, created or prepared for the user 192, the primary entity 193 and/or the secondary entity 196, etc., on the basis of the attribute. As such, in some embodiments, the resource is produced by a determination and/or a computation. In the example of FIG. 1, a resource 179 is produced for the dataset 135, by the computer system 195 applying the certain M_RULE5 175, and in particular its certain consequent CT5, as indicated by the arrow 178. In fact, sometimes applying the consequent is more simply stated as “applying the rule”.

The resource may be produced in a number of ways. For example, the certain consequent can be applied to one of the values of the dataset 135. For instance, one of the values of the dataset 135 can be a numerical base value, e.g. B2, that encodes an aspect of the dataset 135, as mentioned above. In such cases, applying the certain consequent may include performing a mathematical operation on the base value B2. For example, applying the certain consequent may include multiplying the base value B2 with a number indicated by the certain consequent. Such a number can be, for example, a percentage, e.g., 1.5%, 3%, 5%, and so on. Such a number can be indicated directly by the certain rule, or be stored in a place indicated by the certain rule, and so on.

As mentioned above, in some embodiments two or more digital main rules may be applied. For instance, referring again to FIG. 1, the computer system 195 may recognize that an additional condition of an additional one of the accessed digital main rules 170 is met by at least one of the values of the dataset 135, either alone or in combination with other values of other datasets. In this example there would be no digital precedence rules, or the available digital precedence rules would not preclude both the certain digital main rule and the additional digital main rule from being applied concurrently. Such an additional digital main rule would have an additional consequent.

In such embodiments, the resource may be produced by the computer system applying the certain consequent and the additional consequent. For instance, where the base value B1 is used, applying the certain consequent may include multiplying the base value B1 with a first number indicated by the certain consequent, so as to compute a first product. In addition, applying the additional consequent may include multiplying the base value B2 with a second number indicated by the additional consequent, so as to compute a second product. And, the resource may be produced by summing the first product and the second product.

In embodiments, a notification can be caused to be transmitted, e.g., via the network 188, by the computer system. The notification can be about an aspect of the resource, that a condition is met or no longer met, a warning that a condition is or about to be met or no longer be met, that an activity has been or is about to be automatically started or stopped based on a condition being met or no longer being met, and/or include an option to enable or select a setting regarding a service provided by the OSP 198. In the example of FIG. 1, a notification 136 can be caused to be transmitted by the computer system 195, for example as an answer or other response to the received dataset 135. The notification 136 can be about an aspect of the produced resource 179. In particular, the notification 136 may inform about the aspect of the resource 179, namely that it has been determined, where it can be found, what it is, or at least a portion or a statistic of its content, a rounded version of it, and so on. The notification is formatted and transmitted in a manner such that the recipient of the notification 136 understands what it is being provided.

The notification 136 can be transmitted to one of an output device and another device. The output device may be the screen of a local user or a remote user. The notification 136 may thus cause a desired image, message, or other such notification to appear on the screen, such as within a Graphical User Interface (GUI) and so on. The other device can be the remote device, from which the dataset 135 was received, as in the example of FIG. 1. In particular, the computer system 195 may cause the notification 136 to be communicated by being encoded as a payload 137, which is carried by a response 187. The response 187 may be transmitted via the network 188 responsive to the received request 184. The response 187 may be transmitted to the computer system 190, or to OPF 189, and so on. As such, the other device can be the computer system 190, or the OPF 189, or the screen 191 of the user 192, and so on. In this example, the single payload 137 encodes the entire notification 136, but that is not required. Similarly with what is written above about encoding datasets in payloads, the notification 136 instead may be provided via two or more payloads, or in other cases the notification 136 and at least one other notification may be included in the same single payload. Along with the aspect of the resource 179, it can be advantageous to embed in the payload 137 the identity value (ID) and/or one or more values of the dataset 135. This will help the recipient correlate the response 187 to the request 184, and therefore match the received aspect of the resource 179 as the answer or other response to the appropriate dataset.

In an example embodiment, there may be a plurality of relationship instances between the primary entity 193 and one or more secondary entities, such as secondary entity 196. In some embodiments, such relationship instances are between the primary entity 193 and one or more secondary entities, such as secondary entity 196, via one or more intermediary entities (not shown). Each relationship instance may be associated with one or more respective domains of a plurality of domains. In various embodiments, a domain may be a region defined by a boundary as discussed above or may be an entity representing or otherwise associated with the region. For example, the region could be geographic, within the space of a city, a county, a state, a country, a continent or the earth.

For example, in one embodiment, primary entity 193 may have a relationship instance 197 with secondary entity 196 and that particular relationship instance 197 may be associated with one or more domains. The association of the relationship instance 197 with the one or more domains may be based on a variety of characteristics including, but not limited to: a relationship of one or more of the primary entity and secondary entity with the particular domain; a location of one or more of the primary entity and secondary entity within or associated with the particular domain; a region or location associated with one or more of the primary entity and secondary entity being within or associated with the particular domain; a previous relationship of one or more of the primary entity and secondary entity with the particular domain; a location of items associated with one or more of the primary entity and secondary entity within the particular domain; a number of relationships of one or more of the primary entity and secondary entity with the particular domain; a transfer of items associated with one or more of the primary entity and secondary entity to or from an entity within or associated with the particular domain; a transfer of data associated with one or more of the primary entity and secondary entity to or from an entity within or associated the particular domain, etc. The existence or identification of the relationship instance 197 and/or one or more characteristics of the relationship instance 197 may be defined or represented by values of dataset 135.

In some embodiments, for each relationship instance of the plurality of relationship instances represented by dataset 135, the OSP 198 electronically identifies a rate to calculate an amount of resource due to one or more respective domains associated with the relationship instance based on particular attributes of the dataset 135 and the one or more respective domains. For example, the primary entity 193 may send request 184 to the computer system 195 of OSP 198 for services that include producing resources based on the dataset 135. The request 184 may include the existence or identification of the relationship instance 197 and/or one or more characteristics of the relationship instance 197 as part of payload 134. The service engine 183 may then apply digital rules 170 to the relationship instance 197 and/or one or more characteristics of the relationship instance 197 to identify or otherwise determine the rate to calculate an amount of resource due to one or more respective domains associated with the relationship instance.

For example, digital precedence rule P_RULE2 172 may decide that rule M_RULE5 175 is to be applied when a particular condition is met. Digital precedence rule P_RULE2 172 may include a condition that indicates if a particular relationship instance is associated with a particular domain and/or a particular threshold has been crossed due to or otherwise regarding one or more attributes of the relationship instance, either alone or in combination with attributes of other relationship instances, then rule M_RULE5 175 is to be applied. The service engine 183 may determine that the condition is met due to one or more values of dataset 135 indicating the particular relationship instance and that the particular relationship instance is associated with the particular domain and/or a particular threshold has been crossed due to or otherwise regarding one or more attributes of the relationship instance, either alone or in combination with attributes of other relationship instances. Thus, as a consequent of precedence rule P_RULE2 172, the service engine 183 applies rule M_RULE5 175. Rule M_RULE5 175 may include a condition CN5 that indicates if a relationship instance is associated with that particular domain, then, as consequent CT5, a particular rate is to be used to calculate an amount of resource due to that particular domain.

Referring again to FIG. 2, at decision diamond 285 it is determined that the condition CN5 is met (i.e., that a particular attribute of the dataset is associated with a particular domain) and thus, the particular rate is used to calculate an amount of resource due to that particular domain. Thus, by applying digital rules 170, the service engine 183 identifies the rate to calculate an amount of resource due to one or more respective domains associated with the relationship instance based on one or more attributes of the dataset 135, and also calculates an amount of resources due to at least one respective domain associated with the relationship instance based on the identified rate. In some embodiments, this calculated amount of resources due may be included by the service engine 183 as part of the resulting produced resource 179 and/or notification 136. The service engine 183 may then form a payload 137 that is an aspect of the resource 179, and then push, send, or otherwise cause to be transmitted a response 187 that carries the payload 137 to a device remote to the service engine 183, such as computer system 190, a device of secondary entity 196 or another secondary entity. Digital rules 170 may include multiple different digital rules for each type of relationship instance and different domains. In various embodiments, the notification 136 may comprise the response 187, or the response 187 may be included in the notification 136.

In various embodiments, the processes of determining which digital rules 170 apply to the dataset 135 and how to apply them as described with reference to FIG. 2 may also be used by the OSP 198 to determine which, if any, of alignment digital rules 163 apply to the dataset 135 and how to apply them. One or more of the alignment digital rules 163 may indicate the relationship instance 197 represented by the dataset 135 is exempt from a requirement to remit the resource 179 associated with the relationship instance 197. For example, one or more the alignment digital rules 163 may indicate the relationship instance 197 in exemptible (i.e., exempt from a requirement to remit a non-zero resource associated with the relationship instance) based on one or more attributes of the relationship instance 197, including, but not limited to: attributes of the primary entity 193, attributes of the secondary entity 196, and attributes of an item that is the subject of the relationship instance 197.

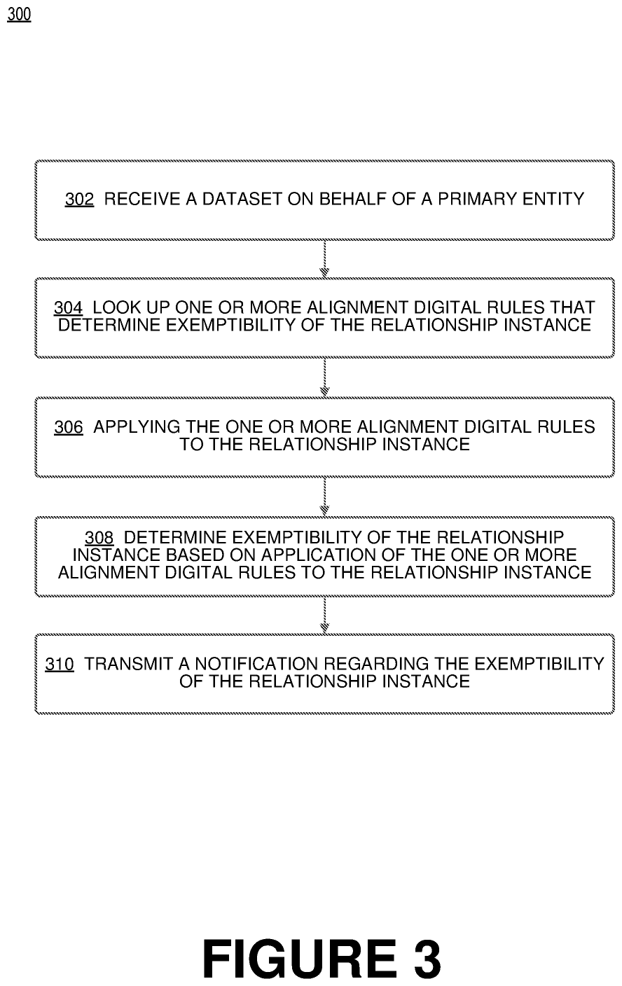

FIG. 3 is a flowchart for illustrating a sample method 300 for transmitting a notification 166 regarding the exemptibility of the relationship instance 197 determined based on applying the one or more alignment digital rules 163 to the relationship instance 197, according to embodiments of the present disclosure, which is an improvement in automated computerized systems.

Although, in the present example, the operations and methods described with reference to the flowcharts illustrated in FIGS. 3-8 are described as being performed by the OSP 198, in various embodiments, one or more of the operations and methods described with reference to the flowcharts illustrated in FIGS. 3-8, or otherwise described herein, may be performed by the primary entity computer system 190 of primary entity 193.

At 302 the OSP 198 receives a dataset on behalf of a primary entity, in which the dataset includes data regarding a relationship instance between the primary entity and a secondary entity.

At 304 the OSP 198 looks up one or more alignment digital rules that determine exemptibility of the relationship instance. The exemptibility indicates whether or not the relationship instance is exempt from a requirement to remit a non-zero resource associated with the relationship instance.

At 306 the OSP 198 applies the one or more alignment digital rules to the relationship instance based on one or more attributes of the relationship instance.

At 308, the OSP 198, determines the exemptibility of the relationship instance based on the application of the one or more alignment digital rules to the relationship instance. For example, the determination of the exemptibility of the relationship instance may be based on one or more of: an item that is a subject of the relationship instance, one or more attributes of the primary entity that is providing the item, one or more attributes of the secondary entity that is receiving the item, one or more attributes of a domain with which the relationship instance is associated, one or more attributes of a location in which the item is received, one or more locations from which the item is sent. In some instances the item is a service provided to the secondary entity. Also, in some embodiments, there is no known prior relationship instance between the primary entity and secondary entity in which application of the alignment digital rules indicated the prior relationship instance was exempt from a requirement to remit a non-zero resource associated with the relationship instance.

At 310, the OSP 198 transmits a notification regarding the exemptibility of the relationship instance. For example, the notification may indicate exemptibility of one or more of: item that is a subject of the relationship instance and the secondary entity. In various embodiments, the notification is transmitted to the primary entity and/or secondary entity. In some embodiments, the notification to the secondary entity may be made by the primary entity (either directly or via the OSP 198) and/or by the OSP 198 directly to the secondary entity. For example, the OSP 198 may enable the primary entity to transmit the notification to the secondary entity. In some embodiments, the relationship instance is an impending relationship instance and the notification includes a recommendation of a possible different production of resources for the relationship instance based on the determination of the exemptibility.

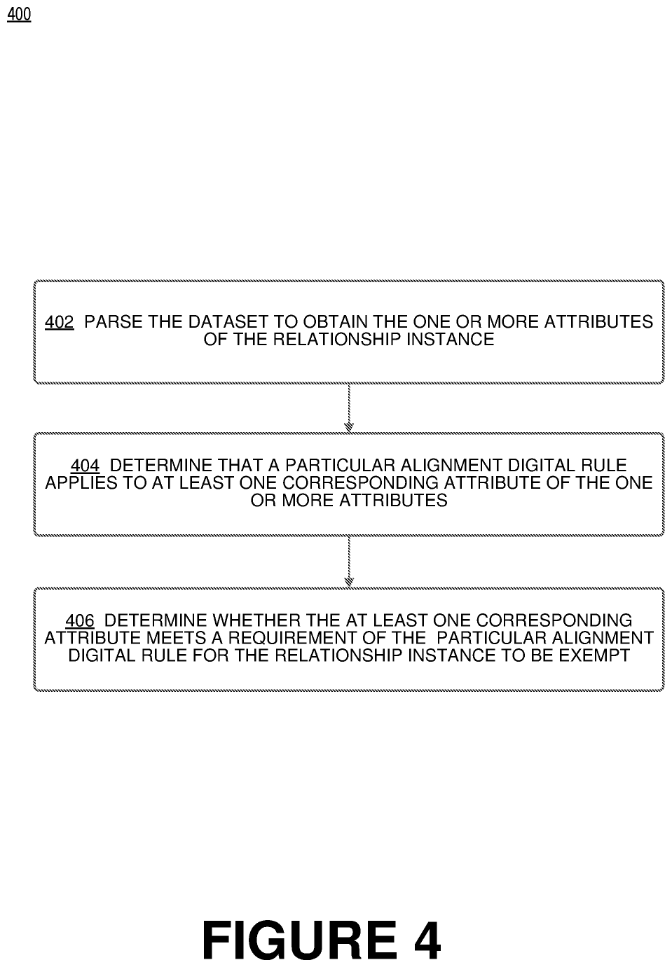

FIG. 4 is a flowchart for illustrating a sample method 400 for applying one or more alignment digital rules 163 to a relationship instance 197 that is useful in the method 300 of FIG. 3, according to embodiments of the present disclosure, which is an improvement in automated computerized systems.

At 402, the OSP 198 parses the dataset to obtain the one or more attributes of the relationship instance.

At 404, the OSP 198 determines that at least one particular alignment digital rule of the one or more looked-up alignment digital rules applies to at least one corresponding attribute of the one or more attributes.

At 406, the OSP 198 determines whether or not the at least one corresponding attribute meets a requirement of the at least one particular alignment digital rule for the relationship instance to be exempt from the requirement to remit a non-zero resource associated with the relationship instance.

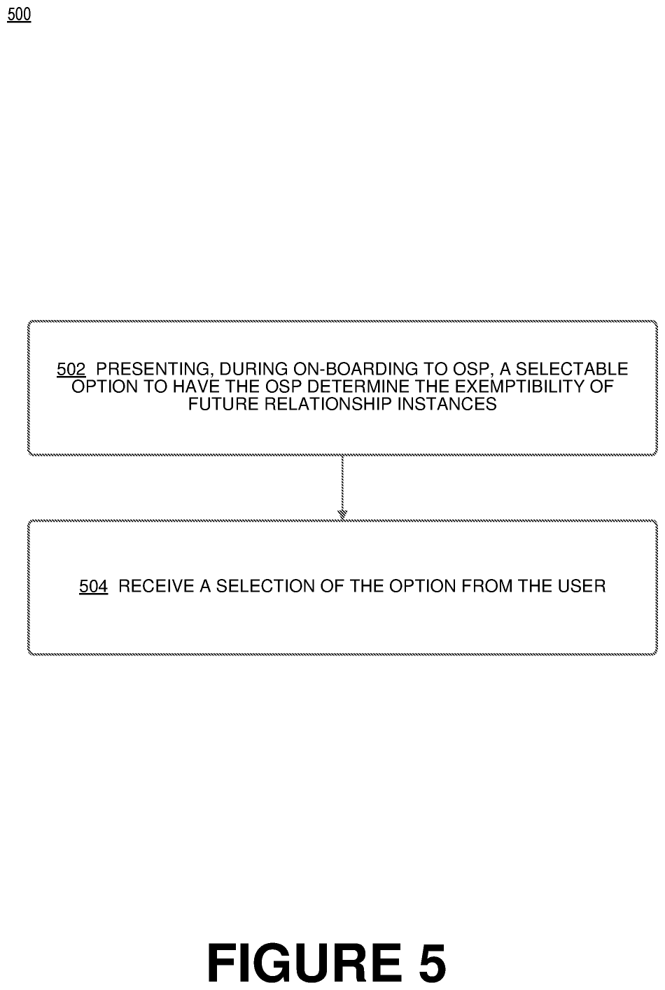

FIG. 5 is a flowchart for illustrating a sample method 500 for presenting selectable options for initiating determination of the exemptibility of future relationship instances that is useful in the method 300 of FIG. 3, according to embodiments of the present disclosure, which is an improvement in automated computerized systems.

At 502, prior to determining the exemptibility as described in method 300, the OSP 198 presents to a user associated with the primary entity, during on-boarding of the primary entity to the OSP 198 when subscribing to services of the OSP 198, a selectable option to have the OSP 198 determine the exemptibility of future relationship instances associated with particular attributes of previous relationship instances associated with the primary entity.

At 504, the OSP 198 receives a selection of the option from the user. In the present example, the dataset used to determine exemptibility includes data regarding a previous relationship instance, the notification is based on the selection of the option, and the notification includes a notification regarding exemptibility of future relationship instances associated with one or more particular attributes of the previous relationship instance.

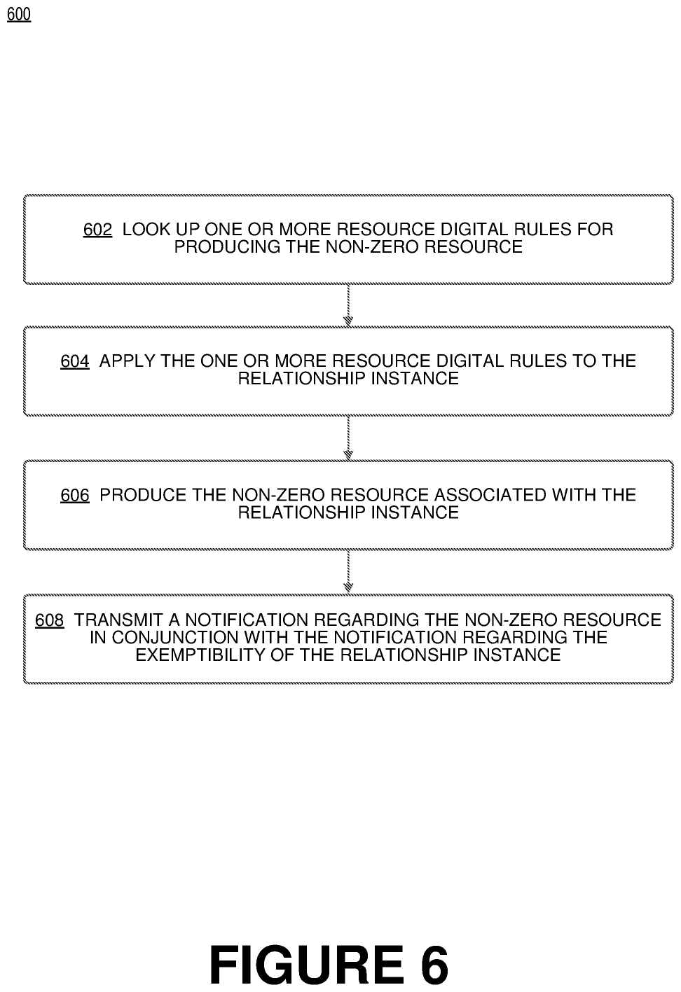

FIG. 6 is a flowchart for illustrating a sample method 600 for transmitting a notification 136 regarding a non-zero resource in conjunction with a notification 166 regarding the exemptibility of the relationship instance 197 that is useful in the method 300 of FIG. 3, according to embodiments of the present disclosure, which is an improvement in automated computerized systems.

At 602, the OSP 198 looks up one or more resource digital rules for producing the non-zero resource associated with the relationship instance.

At 604, the OSP 198 applies the one or more resource digital rules to the relationship instance based on one or more attributes of the relationship instance.

At 606, the OSP 198 produces the non-zero resource associated with the relationship instance based on the application of the one or more resource digital rules to the relationship instance.

At 608, the OSP 198 transmits a notification regarding the non-zero resource in conjunction with the notification regarding the exemptibility of the relationship instance. For example, the notification regarding the non-zero resource may be in the same transmission or notification along with the notification regarding the exemptibility. In some embodiments, the notification regarding the non-zero resource may trigger the notification regarding the exemptibility, or the notification regarding the non-zero resource may link to or be presented adjacent to the notification regarding the exemptibility.

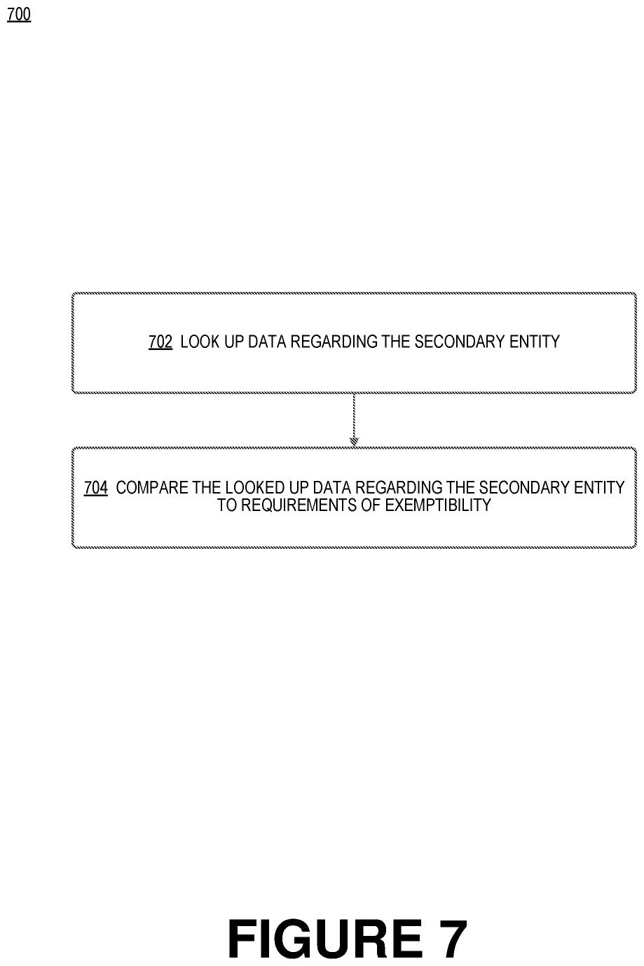

FIG. 7 is a flowchart for illustrating another sample method 700 for applying one or more alignment digital rules 163 to a relationship instance 197 that is useful in the method 300 of FIG. 3, according to embodiments of the present disclosure, which is an improvement in automated computerized systems.

At 702, the OSP 198 looks up data regarding the secondary entity. For example, this may include looking up one or more of: researched content regarding one or more attributes of the relationship instance; usage data regarding one or more attributes of the relationship instance; and information accessed via a trusted remote system that validates one or more aspects regarding the secondary entity or regarding one or more attributes of the relationship instance.

At 704, the OSP 198 compares the looked up data regarding the secondary entity to requirements of exemptibility indicated by the one or more alignment digital rules.

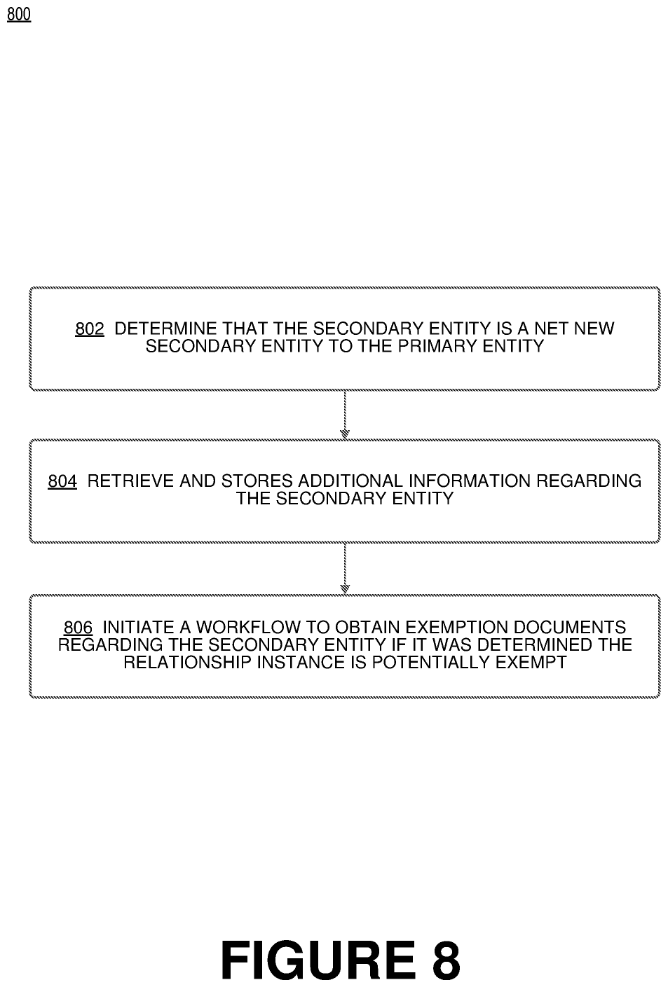

FIG. 8 is a flowchart for illustrating a sample method 800 for using looked-up data regarding a secondary entity 196 to initiate a workflow to obtain exemption documents regarding the secondary entity 196 that is useful in the method 300 of FIG. 3, according to embodiments of the present disclosure, which is an improvement in automated computerized systems.

At 802, the OSP 198 determines that the secondary entity is a net new secondary entity to the primary entity in which the primary entity has not had a previous relationship instance with the secondary entity.

At 804, in response to determining that the secondary entity is a net new secondary entity to the primary entity, the OSP 198 automatically retrieves and stores additional information regarding the secondary entity from the looked-up data regarding the secondary entity.

At 806, the OSP 198 uses the looked-up data regarding the secondary entity to initiate a workflow to obtain exemption documents regarding the secondary entity if it was determined the relationship instance is potentially exempt from a requirement to remit a non-zero resource associated with the relationship instance.

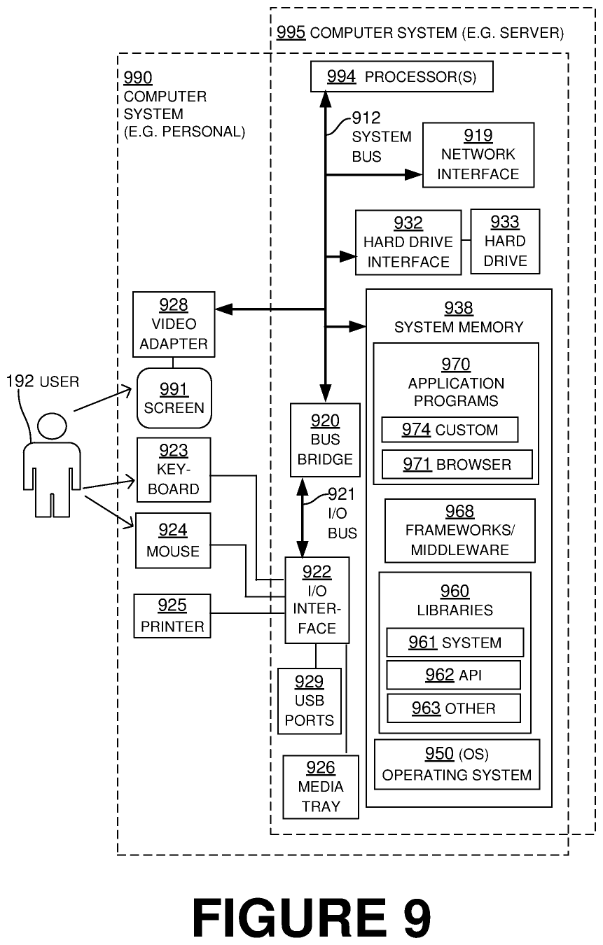

FIG. 9 is a block diagram illustrating components of an exemplary computer system according to some exemplary embodiments, which may read instructions from a machine-readable medium (e.g., a non-transitory computer-readable medium) and perform any one or more of the processes, methods, and/or functionality discussed herein, according to embodiments of the present disclosure, which is an improvement in automated computerized systems.

In the present example, FIG. 9 is a block diagram illustrating components of a sample computer system 990 and a sample computer system 995 according to some exemplary embodiments, which may read instructions from a machine-readable medium (e.g., a non-transitory computer-readable medium) and perform any one or more of the processes, methods, and/or functionality discussed herein. The computer system 995 may be a server, while the computer system 990 may be a personal device, such as a personal computer, a desktop computer, a personal computing device such as a laptop computer, a tablet computer, a mobile phone, and so on. Either type may be used for the computer system 195 and 190 of FIG. 1, a computer system that is part of secondary entity 196 and/or a computer system that is part of any entity or system shown in any of the Figures of the present disclosure.

The computer system 995 and the computer system 990 have similarities, which FIG. 8 exploits for purposes of economy in this document. It will be understood, however, that a component in the computer system 995 may be implemented differently than the same component in the computer system 990. For instance, a memory in a server may be larger than a memory in a personal computer, and so on. Similarly, custom application programs 974 that implement embodiments may be different, and so on.

The computer system 995 includes one or more processors 994. The processor(s) 894 are one or more physical circuits that manipulate physical quantities representing data values. The manipulation can be according to control signals, which can be known as commands, op codes, machine code, etc. The manipulation can produce corresponding output signals that are applied to operate a machine. As such, one or more processors 894 may, for example, include a Central Processing Unit (CPU), a Reduced Instruction Set Computing (RISC) processor, a Complex Instruction Set Computing (CISC) processor, a Graphics Processing Unit (GPU), a Digital Signal Processor (DSP), a Field-Programmable Gate Array (FPGA), an Application Specific Integrated Circuit (ASIC), any combination of these, and so on. A processor may further be a multi-core processor having two or more independent processors that execute instructions. Such independent processors are sometimes called “cores”.

A hardware component such as a processor may also include programmable logic or circuitry that is temporarily configured by software to perform certain operations. For example, a hardware component may include software executed by a general-purpose processor or another type of programmable processor. Once configured by such software, hardware components become specific machines, or specific components of a machine, uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

As used herein, a “component” may refer to a device, physical entity or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. The hardware components depicted in the computer system 995, or the computer system 890, are not intended to be exhaustive. Rather, they are representative, for highlighting essential components that can be used with embodiments.

The computer system 995 also includes a system bus 812 that is coupled to the processor(s) 994. The system bus 912 can be used by the processor(s) 994 to control and/or communicate with other components of the computer system 995.

The computer system 995 additionally includes a network interface 919 that is coupled to system bus 912. Network interface 919 can be used to access a communications network, such as the network 188. Network interface 919 can be implemented by a hardware network interface, such as a Network Interface Card (NIC), wireless communication components, cellular communication components, Near Field Communication (NFC) components, 5G cellular wireless interfaces, transceivers, and antennas, Bluetooth® components such as Bluetooth® Low Energy, Wi-Fi® components, etc. Of course, such a hardware network interface may have its own software, and so on.

The computer system 995 also includes various memory components. These memory components include memory components shown separately in the computer system 995, plus cache memory within the processor(s) 994. Accordingly, these memory components are examples of non-transitory machine-readable media. The memory components shown separately in the computer system 995 are variously coupled, directly or indirectly, with the processor(s) 894. The coupling in this example is via the system bus 912.

Instructions for performing any of the methods or functions described in this document may be stored, completely or partially, within the memory components of the computer system 995, etc. Therefore, one or more of these non-transitory computer-readable media can be configured to store instructions which, when executed by one or more processors 994 of a host computer system such as the computer system 895 or the computer system 890, can cause the host computer system to perform operations according to embodiments. The instructions may be implemented by computer program code for carrying out operations for aspects of this document. The computer program code may be written in any combination of one or more programming languages, including an object-oriented programming language such as Java, Smalltalk or the like, and/or conventional procedural programming languages, such as the “C” programming language or similar programming languages such as C++, C Sharp, etc.

The memory components of the computer system 995 include a non-volatile hard drive 933. The computer system 995 further includes a hard drive interface 932 that is coupled to the hard drive 933 and to the system bus 912.

The memory components of the computer system 995 include a system memory 938. The system memory 938 includes volatile memory including, but not limited to, cache memory, registers and buffers. In embodiments, data from the hard drive 433 populates registers of the volatile memory of the system memory 938.

In some embodiments, the system memory 938 has a software architecture that uses a stack of layers, with each layer providing a particular functionality. In this example the layers include, starting from the bottom, an Operating System (OS) 950, libraries 960, frameworks/middleware 968 and application programs 970, which are also known as applications 970. Other software architectures may include less, more or different layers. For example, a presentation layer may also be included. For another example, some mobile or special purpose operating systems may not provide a frameworks/middleware 968.

The OS 950 may manage hardware resources and provide common services. The libraries 960 provide a common infrastructure that is used by the applications 970 and/or other components and/or layers. The libraries 960 provide functionality that allows other software components to perform tasks more easily than if they interfaced directly with the specific underlying functionality of the OS 950. The libraries 960 may include system libraries 961, such as a C standard library. The system libraries 961 may provide functions such as memory allocation functions, string manipulation functions, mathematical functions, and the like.

In addition, the libraries 960 may include API libraries 962 and other libraries 963, such as for SDKs. The API libraries 962 may include media libraries, such as libraries to support presentation and manipulation of various media formats such as MPEG4, H.264, MP3, AAC, AMR, JPG, and PNG. The API libraries 962 may also include graphics libraries, for instance an OpenGL framework that may be used to render 2D and 3D in a graphic content on the screen 991. The API libraries 962 may further include database libraries, for instance SQLite, which may support various relational database functions. The API libraries 962 may additionally include web libraries, for instance WebKit, which may support web browsing functionality, and also libraries for applications 970.

The frameworks/middleware 968 may provide a higher-level common infrastructure that may be used by the applications 970 and/or other software components/modules. For example, the frameworks/middleware 968 may provide various Graphic User Interface (GUI) functions, high-level resource management, high-level location services, and so forth. The frameworks/middleware 968 may provide a broad spectrum of other APIs that may be used by the applications 970 and/or other software components/modules, some of which may be specific to the OS 950 or to a platform.

The application programs 970 are also known more simply as applications and apps. One such app is a browser 971, which is software that can permit the user 192 to access other devices in the internet, for example while using a Graphic User Interface (GUI). The browser 971 includes program modules and instructions that enable the computer system 995 to exchange network messages with a network, for example using Hypertext Transfer Protocol (HTTP) messaging.

The application programs 970 may include one or more custom applications 974, made according to embodiments. These can be made so as to cause their host computer to perform operations according to embodiments disclosed herein. Of course, when implemented by software, operations according to embodiments disclosed herein may be implemented much faster than may be implemented by a human mind; for example, tens or hundreds of such operations may be performed per second according to embodiments, which is much faster than a human mind can do.

Other such applications 970 may include Enterprise Resource Planning (ERP) application, accounting applications, financial applications, accounting applications, payment systems applications, database and office applications, contacts application, a word processing application, a location application, a media application, a messaging application, and so on. Applications 970 may be developed for the Windows™ operating system, and/or by using the ANDROID™ or IOS™ Software Development Kit (SDK) by an entity other than the vendor of the particular platform, and may be mobile software running on a mobile operating system such as IOS™, ANDROID™, WINDOWS® Phone, or other mobile operating systems. The applications 970 may use built-in functions of the OS 950, of the libraries 460, and of the frameworks/middleware 968 to create user interfaces for the user 192 to interact with.

The computer system 995 moreover includes a bus bridge 920 coupled to the system bus 912. The computer system 995 furthermore includes an input/output (I/O) bus 921 coupled to the bus bridge 920. The computer system 995 also includes an I/O interface 922 coupled to the I/O bus 921.

For being accessed, the computer system 995 also includes one or more Universal Serial Bus (USB) ports 929. These can be coupled to the I/O interface 922. The computer system 995 further includes a media tray 926, which may include storage devices such as CD-ROM drives, multi-media interfaces, and so on.

The computer system 990 may include many components similar to those of the computer system 995, as seen in FIG. 9. In addition, a number of the application programs may be more suitable for the computer system 990 than for the computer system 995.

The computer system 990 further includes peripheral input/output (I/O) devices for being accessed by a user 192 more routinely. As such, the computer system 990 includes a screen 991 and a video adapter 928 to drive and/or support the screen 991. The video adapter 928 is coupled to the system bus 912.

The computer system 990 also includes a keyboard 923, mouse 924, and a printer 925. In this example, the keyboard 923, the mouse 924, and the printer 925 are directly coupled to the I/O interface 922. Sometimes this coupling is wireless or may be via the USB ports 929.

In this context, “machine-readable medium” refers to a component, device or other tangible media able to store instructions and data temporarily or permanently and may include, but is not be limited to: a thumb drive, a hard disk, random-access memory (RAM), read-only memory (ROM), buffer memory, flash memory, optical media, magnetic media, cache memory, an Erasable Programmable Read-Only Memory (EPROM), an optical fiber, a portable digital versatile disc (DVD), an optical storage device, a magnetic storage device, or any suitable combination of the foregoing. The machine that would read such a medium includes one or more processors 994.

The term “machine-readable medium” should be taken to include a single medium or multiple media (e.g., a centralized or distributed database, or associated caches and servers) able to store instructions that a machine such as a processor can store, erase, or read. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methods described herein. Accordingly, instructions transform a general or otherwise generic, non-programmed machine into a specialized particular machine programmed to carry out the described and illustrated functions in the manner described.

A computer readable signal traveling from, to, and via these components may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

### Operational Examples—Use Cases

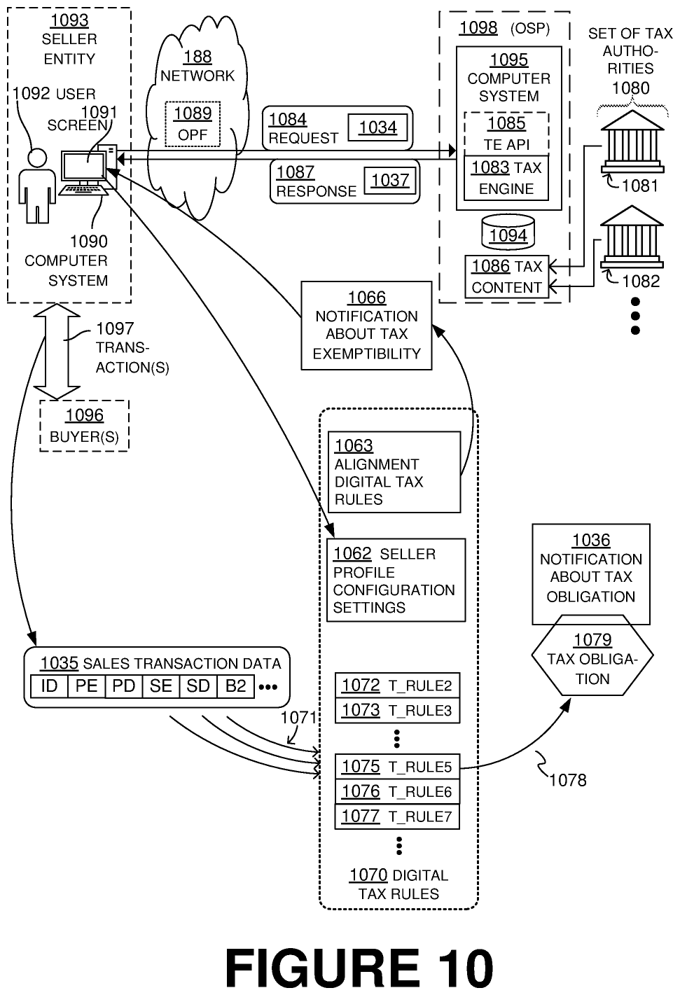

The above-mentioned embodiments have one or more uses. Aspects presented below may be implemented as was described above for similar aspects. (Some, but not all, of these aspects have even similar reference numerals.) FIG. 10 is a diagram of sample aspects for describing operational examples and use cases of embodiments, according to embodiments of the present disclosure.

As a sample use case, tax statutes, tax rules, and tax rates change often, and new tax rules and tax types are continuously added. The OSP 1098 researches the underlying statutes and tax rules and guidance issued by the tax authorities 1080, uses them to generate or obtain digital tax rules 1070 to compute tax obligations (also referred to as tax liabilities) for primary entities, such as seller 1093, and makes the research available to all its primary entities. In addition, the OSP 1098 will keep enhancing its coverage of transaction compliance scenarios by enhancing its content and by building logic to determine increasing numbers of different types of compliance liabilities (e.g. tax types) required to be collected and paid to governing authorities, such as tax authorities 1080. Primary entities trust the OSP 1098 for compliance and may expect the OSP 1098 to take an increasing amount of compliance burden away from their shoulders. However, with more than 10,000 tax jurisdictions in USA alone, it is a mammoth task to stay on top of these changes. For example, different tax jurisdictions have different rules for when a seller is required to collect and remit sales tax. A tax authority such as a state or even a city may set its own economic nexus rules for when a business is considered to be “engaged in business” with it, and therefore that business is subject to registration and collection of sales taxes. These nexus rules are often based on thresholds indicating a total number of sales transactions and/or a total monetary value of all sales in a given time period. It is a technical challenge for a business, such as seller 1093, to constantly ascertain whether it meets these different nexus requirements in different tax jurisdictions in real time as transactions occur given the ever changing amount of sales in various different tax jurisdictions for the business in various time periods.

Furthermore, transactions involving certain (or types of) goods, services, buyers and sellers may be exempt from transaction taxes in various circumstances according to various tax rules that change frequently. It is also a technical challenge for the computerized systems of a business, such as seller 1093, and of a buyer, such as buyer 1096, to constantly ascertain whether their transactions meet these different requirements to be exempt from various different transaction taxes in different tax jurisdictions in real time as transactions occur given the number of different taxes, tax jurisdictions and requirements that often change.

Thus, to solve the solve the above technical problems, embodiments include functionality that enables the OSP 1098 to automatically notify the seller 1093 and/or buyer 1096 that an impeding transaction 1097 may be exempt from one or more transaction taxes. This notification about tax exemptibility 1066 of the transaction 1097 may include a recommendation for different digital tax rule treatment of the transaction 197 by the OSP 1098. For example, one or more digital tax rules 1070 may be applied differently, or not applied at all, based on the transaction 1097 being exempt from one or more particular transaction taxes.

In one embodiment, The OSP 1098 receives a dataset 1035 on behalf of the seller 1093. The dataset 1035 includes data regarding a transaction 1097 between the buyer 1096 and seller 1093. The OSP 1098 then looks up one or more alignment digital tax rules 1063 that determine exemptibility of the transaction 1097. In some embodiments, the exemptibility indicates whether or not the transaction 1097 is exempt from a requirement to remit a non-zero tax obligation 1079 associated with the transaction 1097 (i.e., is exempt from taxation). Note that the transaction 1097 may be exempt from taxation for one or more particular types of transaction tax, but in some cases may not be exempt from other types of transactions taxes, and the alignment digital tax rules 1063 may determine or indicate such. The OSP 198 applies the one or more alignment digital tax rules 1063 to the transaction 1097 based on one or more attributes of the transaction 1097 to determine whether the transactions exempt from one or more transaction taxes.

In various embodiments, the alignment digital tax rules 1063 may indicate certain types of buyers, products, services, and/or intended uses of products or services involved in the transaction 1097 may cause the transaction 1097 to be exempt from sales tax. For example, in some states, grocery items or certain types of grocery items are exempt from sales tax. (e.g., prepared foods, such as a ready-to-eat rotisserie chicken purchased from the deli, may be taxable; at the same time, a package of chicken breasts the buyer will cook at home might be exempt). There also may be use-based exemptions. Products that are intended to be resold are frequently exempted from sales tax. Typically, this is because the reseller will charge sales tax when these items are purchased by the end user. Regarding buyer-based exemptions, nonprofit organizations or government agencies often are not required to pay sales tax (e.g., states cannot charge sales tax on items purchased by the federal government, and often this exemption is extended to state agencies as well). Also, buyers from states without a sales tax can sometimes be exempted from paying tax when purchasing products in other states. The OSP 1098 determines the exemptibility of the transaction 1097 based on the application of the one or more alignment digital tax rules 1063 to the transaction 1097 and then transmits a notification 1066 about tax exemptibility of the transaction 1097 to the seller 1093 and/or buyer 1096.

Operational examples and sample use cases are possible where the attribute of an entity in a dataset is any one of: the entity's name; type of entity; a physical location such as an address; a contact information element; transactions of the entity; an identifier of a specific source of revenue received for a transaction of the entity; characteristics of transactions of the entity; licensure and/or or registration of the entity and/or products or services the entity produces, sells, stores and/or transfers; products or services produced, sold, stored and/or transferred by the entity; types of products or services produced, sold, stored and/or transferred by the entity; a location to which products are sent, shipped or transferred; a location from which products are received; a location of a property owned by the entity; a location of a property owned by the entity within a particular region of other domain; an affiliation; a characterization of another entity; a characterization by another entity; an association or relationship with another entity (general or specific instances); an asset of the entity; a declaration by or on behalf of the entity; and so on. Different resources may be produced in such instances, and so on.

In particular, FIG. 10 is diagram for an operational example and use case where the resource 1079 includes a tax obligation of a primary entity, such as seller 1093 of goods or services and/or a secondary entity, such as buyer 1096 of goods or services, due to a transaction 1097. It will be recognized that aspects of FIG. 10 have similarities with aspects of FIG. 1. Portions of such aspects may be implemented as described for analogous aspects of FIG. 1. In particular, a computer system 1095 is shown, which is used to help primary entities, such as a seller 1093 and an associated user 1092, with tax compliance. Further in this example, the computer system 1095 is part of an OSP 1098 that is implemented as a Software as a Service (SaaS) provider, for being accessed by the user 1092 online. Alternately, the functionality of the computer system 1095 may be provided locally to a user.

The user 1092 may be standalone. The user 1092 may use a computer system 1090 that has a screen 1091. In embodiments, the user 1092 and the computer system 1090 are considered part of the seller 1093, which is also known as entity 1093. The seller 1093 can be a business, such as a seller of items, a reseller, and so on. The user 1092 can be an employee, a contractor, or otherwise an agent of the entity 1093. In use cases, the seller 1093 and the buyer 1096 are performing the buy-sell transaction 1097. The transaction 1097 will have data that is known to the seller 1093, similarly with what was described by the relationship instance 197 of FIG. 1B.

In a number of instances, the user 1092 and the seller 1093 use software applications to manage their business activities, such as sales, resource management, production, inventory management, delivery, billing, and so on. The user 1092 and/or the seller 1093 may further use accounting applications to manage purchase orders, reservations, bookings, sales invoices, refunds, payroll, accounts payable, accounts receivable, and so on. Such software applications, and more, may be used locally by the user 1092 or from an Online Processing Facility (OPF) 1089 that has been engaged for this purpose by the user 1092, and/or the seller. In such use cases, the OPF 1089 can be a Mobile Payments system, a Point of Sale (POS) system, an Accounting application, an Enterprise Resource Planning (ERP) provider, an e-commerce provider, an electronic marketplace, a Seller Relationship Management (CRM) system, and so on.

Businesses have tax obligations to various tax authorities of respective domains (e.g., respective tax jurisdictions). A first challenge is in making the related determinations. Tax-related determinations, made for the ultimate purpose of tax compliance, are challenging because the underlying statutes and tax rules and guidance issued by the tax authorities are very complex. There are various types of tax, such as sales tax, use tax, excise tax, value-added tax, lodging tax, and issues about cross-border taxation including customs and duties, and many more. Some types of tax are industry specific. Each type of tax has its own set of rules. Additionally, statutes, tax rules, and rates change often, and new tax rules are continuously added. Compliance becomes further complicated when a taxing authority, such as tax authority 1081 or tax authority 1082 promulgates new tax types and/or tax exemption rules of which the seller 1093 is presently unaware.

Tax jurisdictions are defined mainly by geography. Businesses have tax obligations to various tax authorities within the respective tax jurisdictions. There are various tax authorities, such as that of a country, of a state, of a municipality, of a local district such as a local transit district and so on. So, for example, when a business sells items in transactions that can be taxed by a tax authority, the business may have the tax obligations to the tax authority. These obligations include requiring the business to: a) register itself with the tax authority's taxing agency, b) set up internal processes for collecting sales tax in accordance with the sales tax rules of the tax authority, c) maintain records of the sales transactions and of the collected sales tax in the event of a subsequent audit by the taxing agency, d) periodically prepare a form (“tax return”) that includes an accurate determination of the amount of the money owed to the tax authority as sales tax because of the sales transactions, e) file the tax return with the tax authority by a deadline determined by the tax authority, and f) pay (“remit”) that amount of money to the tax authority. In such cases, the filing and payment frequency and deadlines are determined by the tax authority.

A technical problem for businesses is that the above-mentioned software applications generally cannot provide tax information that is accurate and current enough for the businesses to be tax compliant with all the relevant tax authorities. The lack of accuracy may manifest itself as errors in the amounts determined to be owed as taxes to the various tax authorities, and it is plain not good to have such errors. For example, businesses that sell products and services have risks whether they over-estimate or under-estimate the sales tax due from a sale transaction. On the one hand, if a seller over-estimates the sales tax due, then the seller collects more sales tax from the buyers than was due. Of course, the seller may not keep this surplus sales tax, but instead must pay it to the tax authorities—if they cannot refund it to the buyers. If a buyer later learns that they paid unnecessarily more sales tax than was due, the seller risks at least harm to their reputation. Sometimes the buyer will have the option to ask the state for a refund of the excess tax by sending an explanation and the receipt, but that is often not done as it is too cumbersome. On the other hand, if a seller under-estimates the sales tax due, then the seller collects less sales tax from the buyers, and therefore pays less sales tax to the authorities than was actually due. That is an underpayment of sales tax that will likely be discovered later, if the tax authority audits the seller. Then the seller will be required to pay the difference, plus fines and/or late fees, because ignorance of the law is not an excuse. Further, one should note that sales taxes are considered trust-fund taxes, meaning that the management of a company can be held personally liable for the unpaid sales tax.

For sales in particular, making correct determinations for sales and use tax is even more difficult. There are a number of factors that contribute to its complexity.

First, some state and local tax authorities have origin-based tax rules, while others have destination-based tax rules. Accordingly, a sales tax may be charged from the seller's location or from the buyer's location.

Second, the various tax authorities assess different, i.e. non-uniform, percentage rates of the sales price as sales tax, for the purchase and sale of items that involve their various tax jurisdictions. These tax jurisdictions include various states, counties, cities, municipalities, special taxing jurisdictions, and so on. In fact, there are over 10,000 different tax jurisdictions in the US, with many partially overlapping.

Third, in some instances no sales tax is due at all because of the type of item sold. For example, in 2018 selling cowboy boots was exempt from sales tax in Texas, but not in New York. This non-uniformity gives rise to numerous individual taxability rules related to various products and services across different tax jurisdictions.

Fourth, in some instances no sales tax is due at all because of who the individual buyer is. For example, certain entities are exempt from paying sales tax on their purchases, so long as they properly create and sign an exemption certificate and give it to the seller for each purchase made. Entities that are entitled to such exemptions may include wholesalers, resellers, non-profit charities, educational institutions, etc. Of course, who can be exempt is not exactly the same in each tax jurisdiction. And, even when an entity is entitled to be exempt, different tax jurisdictions may have different requirements for the certificate of exemption to be issued and/or remain valid.

Fifth, it can be difficult to determine which tax authorities a seller owes sales tax to. A seller may start with tax jurisdictions that it has a physical presence in, such as a main office, a distribution center or warehouse, an employee working remotely, and so on. Such ties with a tax jurisdiction establish the so-called physical nexus. However, a tax authority such as a state or even a city may set its own nexus rules for when a business is considered to be “engaged in business” with it, and therefore that business is subject to registration and collection of sales taxes. These nexus rules may include different types of nexus, such as affiliate nexus, click-through nexus, cookie nexus, economic nexus with thresholds, and so on. For instance, due to economic nexus, a remote seller may owe sales tax for sales made in the jurisdiction that are a) above a set threshold volume, and/or b) above a set threshold number of sales transactions.

To help with such complex determinations and solve such technical problems, the computer system 1095 may be specialized device for tax compliance as disclosed herein. The computer system 1095 may have one or more processors and memory, for example, as was described for the computer system 195 of FIG. 1. The computer system 1095 thus implements a tax engine 1083 to determine sales tax obligations on transactions associated with a particular jurisdiction for sellers based on various criteria of the digital tax rules 1070. The tax engine 1083 can be as described for the service engine 183.

The computer system 1095 may further store locally entity data, i.e. data of user 1092, of entity 1093, any of which/whom may be a seller, and/or a seller or a buyer in a sales transaction in various embodiments. The entity data may include profile data of the seller and transaction data from which a determination of a tax obligation is desired. In the online implementation of FIG. 10, the OSP 1098 has a database 1094 for storing the entity data. This entity data may be inputted by the user 1092, and/or caused to be downloaded or uploaded by the user 1092 from the computer system 1090 or from the OPF 1089, or extracted from the computer system 1090 or from the OPF 1089, and so on. In other implementations, a simpler memory configuration may suffice for storing the entity data.

Digital tax content 1086 is further implemented within the OSP 1098. The digital tax content 1086 can be a utility that stores digital tax rules 1070 for use by the tax engine 1083. As part of managing the digital tax content 1086, there may be continuous updates of the digital tax rules, by inputs gleaned from a set 1080 of different tax authorities 1081, 1082, . . . . Updating may be performed by humans, or by computers, and so on. As mentioned above, the number of the different tax authorities in the set of tax authorities 1080 may be very large and the digital tax rules resulting from tax regulations promulgated by such tax authorities in the set 1080, once recognized and stored by the OSP 1098, may be used to determine whether economic nexus thresholds have been met or exceeded and to determine whether one or more transactions, products, services, buyers and/or sellers are exempt from one or more transaction taxes.

For a specific determination of a tax obligation, the computer system 1095 may receive one or more datasets. A sample received dataset 1035 can be similar to what was described for the dataset 135 of FIG. 1. In this example, the computer system 1090 transmits a request 1084 that includes a payload 1034, and the dataset 1035 is received by the computer system 1095 parsing the received payload 1034. In this example, the single payload 1034 encodes the entire dataset 1035, but that is not required, as mentioned earlier. The request 1084 may also include particular option selections regarding the one or more predefined services that the OSP 198 can be configured to perform, such as options regarding receiving notifications about the exemptibility of past, impending and/or future transactions. For example, such notifications, such as notification 1066, may be received in response to the OSP 098 applying one or more alignment digital tax rules 1063 to the impending transaction 1097 based on one or more attributes of the impending transaction 1097 (e.g. as indicated by the dataset 1035). In some embodiments, the seller 1093 may have pre-set preferences stored in the seller profile configuration settings 1062 indicating whether the seller 1093 would like to receive such notifications regarding exemptibility and how such notifications should be handled, such as by optionally transmitting such a notification including the recommendation about exemptibility instead or also to the buyer 1096.

The tax engine 1083 may communicate with various other systems, programs, entities and remote devices via a tax engine (TE) API 1085. The TE API 1085 may be designed to take advantage of existing protocols. While REST API can be used over nearly any protocol, it usually takes advantage of HTTP (Hyper Text Transfer Protocol) when used for Web APIs. This architecture enables the seller 1093 to directly consume a REST API from their particular application, without using a connector. The particular application of the remote device may be able to fetch internally from the remote device the details required for the service desired from the OSP 1098, and thus send or push the request 1084 to the TE API 1085. In turn, the TE API 1085 talks in the background to the tax engine 1083. The tax engine 1083 determines the requested tax obligation 0179, and sends an aspect of it back to the TE API 1085.

In this example, the dataset 1035 has been received because it is desired to determine any tax obligations arising from the buy-sell transaction 1097. As such, the sample received dataset 1035 has values that characterize attributes of the buy-sell transaction 1097. Accordingly, in this example the sample received dataset 1035 has a value ID for an identity of the dataset 1035 and/or the transaction 1097. The dataset 1035 also has a value PE for the name of the seller 1093 or the user 1092, which can be the seller 1093 making sales transactions, some online. The dataset 1035 further has a value PD for relevant data of the seller 1093 the user 1092, or the transaction, such as calendar year of the transaction, an address, place(s) of business, prior nexus determinations with various tax jurisdictions, and so on. The dataset 1035 also has a value SE for the name of the buyer 1096. The dataset 1035 further has a value SD for relevant data of the buyer 1096, entity-driven exemption status, and so on. The dataset 1035 has a value B2 for the sale price of the item sold.

The dataset 1035 may have fewer values or have additional values, as indicated by the dot-dot-dot in the dataset 1035. These values may characterize further attributes, such as characteristics of the item being sold, data identifying of or otherwise relating to a license or registration required for the transaction, a date and possibly also time of the transaction 1097, and so on.

The digital tax rules 1070 have been created so as to accommodate tax rules that the set 1080 of different tax authorities 10981, 1082 . . . promulgate within the boundaries of their tax jurisdictions. In FIG. 5, five sample digital tax rules are shown, namely T_RULE2 1072, T_RULE3 1073, T_RULE5 1075, T_RULE6 1076 and T_RULE7 1077. Additional digital tax rules 1070 are suggested by the vertical dot-dot-dots. Similarly with FIG. 1, some of these digital tax rules may be digital main rules that determine the tax obligation 1079, while others can be digital precedence rules that indicate economic thresholds, determine when economic thresholds are crossed or which of the digital main rules is to be applied in the event of conflict. In some use cases, digital main tax rules may be about a sales tax or use tax being owed due to the transaction 1097 at a certain percentage of the purchase price. Digital precedence rules may be digital tax rules that determine whether particular digital tax rules are to be applied for origin-based or destination-based jurisdictions, how to override for diverse taxability of individual items, for temporary tax holidays, for exemptions from having to pay sales tax based on who the buyer is, and also based on nexus, and so on. In the present example, digital precedence rules may be digital tax rules that determine whether particular digital tax rules are to be applied based on exemptibility standards and may include or comprise the alignment digital tax rules 1063.

Similarly with FIG. 2, these digital tax rules 1070 including alignment digital tax rules 1063 can be implemented or organized in different ways. In some use cases they can be organized with conditions and consequents, such as was described earlier in this document. Such conditions may relate to geographical boundaries, sources of revenue, effective dates, types of goods or services being sold, and so on, for determining where and when a digital tax rule or tax rate is to be applied. These conditions may be expressed as logical conditions with ranges, dates, other data, and so on. Values of the dataset 1035 can be iteratively tested against these logical conditions according to arrows 1071. In such cases, the consequents may indicate one or more economic thresholds and tax obligations, such as to indicate different types of taxes that are due, rules, rates, exemption requirements, reporting requirements, remittance requirements, etc.

In this example, a certain digital tax rule T_RULE5 1075 is shown as identified and used, which is indicated also by the beginning of an arrow 1078. Identifying may be performed responsive to the values of the dataset 1035, which are shown as considered for digital tax rules 1070 by arrows 1071. For example, it can be recognized that a condition of the digital tax rule T_RULE5 1075 is met by one or more of the values of the dataset 1035.

As such, the computer system 1095 may produce the tax obligation 1079 and tax return document, which is akin to producing the resource 179 of FIG. 1. The computer system 1095 may also file or otherwise send (or cause to be filed or sent) the tax return document to one or more of the applicable tax authorities in the set of tax authorities 1080 via network 188. The tax obligation 1079 can be produced by the computer system 1095 applying the certain digital tax rule T_RULE5 1075, as indicated by the arrow 1078. In this example, the consequent of the identified certain digital tax rule T_RULE5 1075 may specify that an economic threshold has been met or exceeded and thus a sales tax is due for an item, the amount is to be determined by a multiplication of the sale price of the value B2 by a specific rate, the tax return form that needs to be prepared and filed, a date by which it needs to be filed, and so on.

The computer system 1095 may then cause a notification 1036 to be transmitted. The notification 1036 can be about an aspect of the tax obligation 1079, similarly with the notification 136 of FIG. 1. In the example of FIG. 10, the notification 1036 is caused to be transmitted by the computer system 1095 as an answer to the received dataset 1035. The notification 1036 can be about an aspect of the tax obligation 1079. In particular, the notification 1036 may inform about the aspect of the tax obligation 1079, namely that it has been determined, where it can be found, what it is, or at least a portion or a statistic of its content, and so on.

The notification 1036 can be transmitted to one of an output device and another device that can be the remote device, from which the dataset 1035 was received. The output device may be the screen of a local user or a remote user. The notification 1036 may thus cause a desired image to appear on the screen, such as within a Graphical User Interface (GUI) and so on. The other device may be a remote device, as in this example. In particular, the computer system 1095 causes the notification 1036 to be communicated by being encoded as a payload 1037, which is carried by a response 1087. The response 1087 may be transmitted via the network 188 responsive to the received request 1084. The response 1087 may be transmitted to the computer system 1090, or to OPF 1089, and so on. As such, the other device can be the computer system 1090, a device of the OPF 1089, or the screen 1091 of the user 1092, and so on. In this example the single payload 1037 encodes the entire notification 1036, but that is not required, similarly with what is written above about encoding datasets in payloads. Along with the aspect of the tax obligation 1079, it is advantageous to embed in the payload 1037 the ID value, one or more values of the dataset 1035 and/or one or more of the digital tax rules 1070 used to compute the tax obligation 1079. This will help the recipient correlate the response 1087 to the request 1084, and therefore match the received aspect of the tax obligation 1079 as the answer to the received dataset 1035.

The alignment digital tax rules 1063 may be identified and applied to seller data, such as the seller sales transaction data represented by dataset 1035, in the same or similar manner described above for the other digital tax rules of digital tax rules 1070, such as T_RULE2 1072, T_RULE3 1073, T_RULE5 1075, T_RULE6 1076 and T_RULE7 1077. The notification about tax exemptibility 1066 may also be communicated in the same or similar manner described above for the notification 1036.

In an example embodiment, the OSP 1098 includes functionality described herein that enables buyer awareness for the seller 1093. In particular, the OSP 1098 helps the seller 1093 understand if people they do business with, such as buyer 1096, are exempt from various transaction taxes. Utilizing the functionality described herein, the OSP 1098 creates a virtuous cycle of tax compliance that is ever expanding as the seller 1093 brings more of their customers (e.g., buyer 1096) into the OSP 1098 ecosystem, automatically without extra effort, through their natural business activity monitored by the OSP 1098 and growth. The OSP 1098 creates a multi-level-marketing effect/network effect where the seller 1093 refers the OSP 1098 to buyers, such as buyer 1096, because of value generation for the buyer 1096. In some embodiments, the buyer 1096 receives a discounted or free offering for tax compliance services from the OSP 1098 and the seller 1093 also receives a value add plus a referral benefit from the OSP 1098 in the future. In some embodiments, in conjunction with the notification about tax exemptibility 1066 being sent to the seller 1093 and/or buyer 1096, the buyer 1096 electronically receives a free tax exemption report or audit defense packet via the OSP 1098 with documentation electronically generated and provided by seller 1093 using the OSP 1098. The OSP 1098 may also enable tax compliance of buyers, such as buyer 1096, for example, at each point of compliance in a value-added tax (VAT) regime.

In an example embodiment, the notification 1066 about tax exemptibility may include a recommendation generated from previously stored digital rules, such as alignment digital rules 1063, about one or more of: exemptibility of an item that is the subject of the impending transaction 1097; intended use of the item; knowledge about one or more parties (e.g., seller 1093 and/or buyer 1096) to the impending transaction 1097; identity of the buyer 1096; entity type of buyer 1097; circumstances in which there is no known such prior instances where the digital alignment rules 1063 were applied regarding the buyer 1096 (e.g., in which the buyer 1096 has no prior exemption certificates); and instances in which exemption requirements are looked up using APIs from tax jurisdictions, such as from tax authorities 1080.

An exemption certificate or exemption qualification for a buyer depends on jurisdictional rules of various tax jurisdictions, the product being purchased, and the intended use of purchase. Traditionally, it is up to the buyer 1096 to recognize that they could claim exemption from sales tax in a transaction. For the times that this is recognized (either by the buyer 1096 or via the notification about exemptibility 1066), the OSP 1098 has electronic services and products to support the seller 1093 to help the buyer 1096 to generate a tax exemption certificate by using a wizard or other software application. For example, the wizard may be linked to, or automatically initiated by, a selectable user interface element in the notification about exemptibility 1066. The seller 1093 may then be able to electronically capture or otherwise collect the exemption certificate from the buyer 1096 by initiating such a process from a selectable user interface element provided by or linked to the notification 1066. Also, in response to or otherwise based on the application of the alignment digital tax rules 1063 to the transaction 1097, the OSP 1098 may automatically search for prior exemption certificates of the buyer 1096 and, if found, and they are current, the OSP 1098 may apply the exemption to the transaction 1097. In various embodiments, the OSP 1098 generates this recognition of exemptibility via determining the exemptibility by application of the alignment digital tax rules 1063, even when the buyer 1096 does not have past exemption certificates, and suggests for the buyer to obtain, and assists the buyer in obtaining, the exemption certificates via the notification 1066 and/or UI provide by the OSP 198.

The determination of exemptibility of the transaction 1097 by application of the alignment digital tax rules 1063 may be implemented by the OSP 1098 based on various different information obtained by the OSP 1098, including, but not limited to, information regarding one or more of: item exemptibility (e.g., based on content researched and built by the OSP 1098 for product taxability over the years, which can also be used to suggest product possible exemptibility); intended use of the item; knowledge about the buyer 1096 having no prior exemption certificates; identity of the buyer; buyer entity type; name of the buyer parsed from dataset 1035 or other sources; keywords associated with tax exemption (e.g., “church”, “synagogue”, “school”, “not-for-profit”, etc.); and information regarding the buyer looked up using APIs from tax jurisdictions, such as form tax authorities 1080.

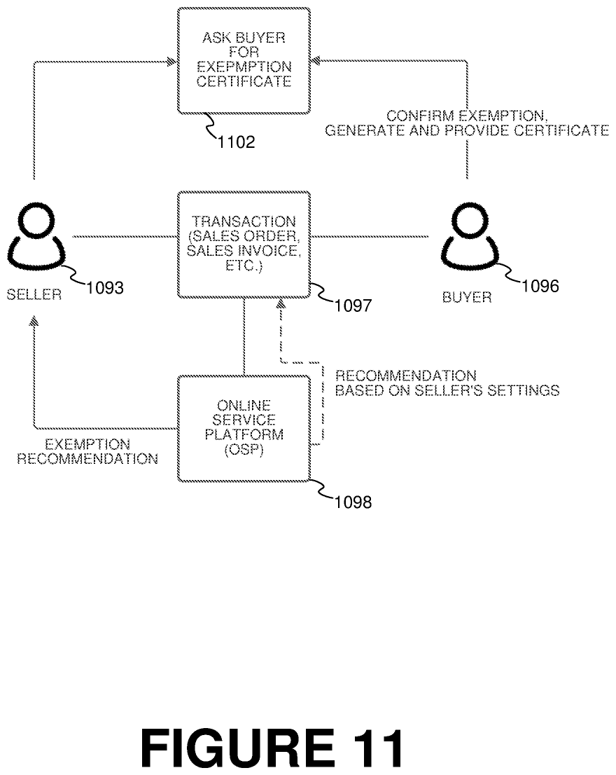

FIG. 11 is a block diagram showing entities and example interaction between such entities according to an example use case of an embodiment of the present disclosure, which is an improvement in automated computerized systems.

Shown is the seller 1093, the buyer 1096 and the OSP 1098. The OSP 1098 analyzes the transaction 1097 between the seller 1093 and buyer 1096 to make a recommendation regarding the exemptibility of the transaction and transmit the recommendation based on setting of the seller in the account of the seller at the OSP 1098. For example, the seller 1093 may have pre-set preferences stored in the seller profile configuration settings 1062 indicating whether the seller 1093 would like to receive such notifications regarding exemptibility and how such notifications should be handled, such as by optionally transmitting such a notification including the recommendation about exemptibility instead or also to the buyer 1096.

As part of, in response to, or otherwise in conjunction with, receiving the recommendation regarding the exemptibility of the transaction 1097, the seller 1093 may send a communication 1102 asking the buyer 1096 for an exemption certificate. This communication 1102 may in some embodiments be sent to the buyer 1096 via the OSP 1098. In some embodiments, the buyer 1096 may then confirm the exemption and provide the exemption certificate via the OSP 1098.

In some embodiments, the OSP 1098 makes a recommendation (e.g., via the notification 1066 of FIG. 10) to the seller 1093 that the transaction 1097 can be exemption worthy if the buyer 1096 can submit the respective exemption certificate. Accordingly, UIs of the OSP 1098 permit the seller 1093 to notify the buyer 1096 of this. Implementing this leads sellers to be liked by buyers and overall causes a network effect of liking the electronic services and products of the OSP 1098 and using them by seller-buyer/tax collector-tax payor ecosystems.

In some embodiments, the OSP 1098 makes recommendation (e.g., via the notification 1066 of FIG. 10) as part of the seller-buyer transaction workflow. For example, the OSP 1098 can configure the workflow to have the buyer 1096 see the exemption worthiness recommendation and then take appropriate action to generate the certificate. For example, the seller 1093 may send a tax calculation request, (such as request 1084 of FIG. 10), to OSP 1098. The OSP 1098 then compares the information available (e.g., buyer, product, and address information associated with the transaction 1097) using the alignment digital tax rules 1063 of FIG. 10. In various embodiments, this can be done in an automated fashion by one or more of: the OSP 1098 comparing researched content of the OSP 1098 (e.g., as stored in tax content 1086 of FIG. 10); the OSP 1098 parsing relevant data from the dataset 1035 of FIG. 10 representing the transaction 1097; the OSP 1098 looking at the usage data regarding one or more attributes of the transaction 1097; and the OSP 1098 electronically calling (e.g., via an API) one or more of the tax authorities 1080 of FIG. 10 and validating the buyer 1096 and product information associated with the transaction 1097.

The OSP 1098 understands if the buyer 1096 is a net new customer for seller 1093. The OSP 1098 creates a customer management service that also includes an exemption claim service that is lightweight and easily called during a calculation operation of the tax engine 1083 to determine if the buyer 1096 is a net new customer for seller 1093 and, if so, to then automatically retrieve and store additional information in the OSP 1098 services on the buyer 1096, initiating a workflow that would require the buyer 1096 to upload tax exemption certificate documents to the OSP 1098. In some embodiments, the OSP 198 would already have captured those documents when validating the buyer 1096 and product information associated with the transaction 1097 with the tax authorities 1080 of FIG. 10 as described above and then provides a recommended tax calculation a priori for the seller 1093 based on the findings of the OSP 1098 through the automated workflow.

Via sales transaction data and other sources, the OSP 1098 automatically retrieves and stores key information on buyers, such as buyer 1096, which illuminates their business activity and role in the supply chain, and thus the potential exemptibility of transaction involving such buyers. Examples of such information include, but are not limited to: buyers' name(s), addresses, and types of businesses in which they operate; whether the OSP 1098 is currently providing or has provided services to capture tax exemption certificates for the buyer, and whether the buyer has a tax exemption on record already, etc.

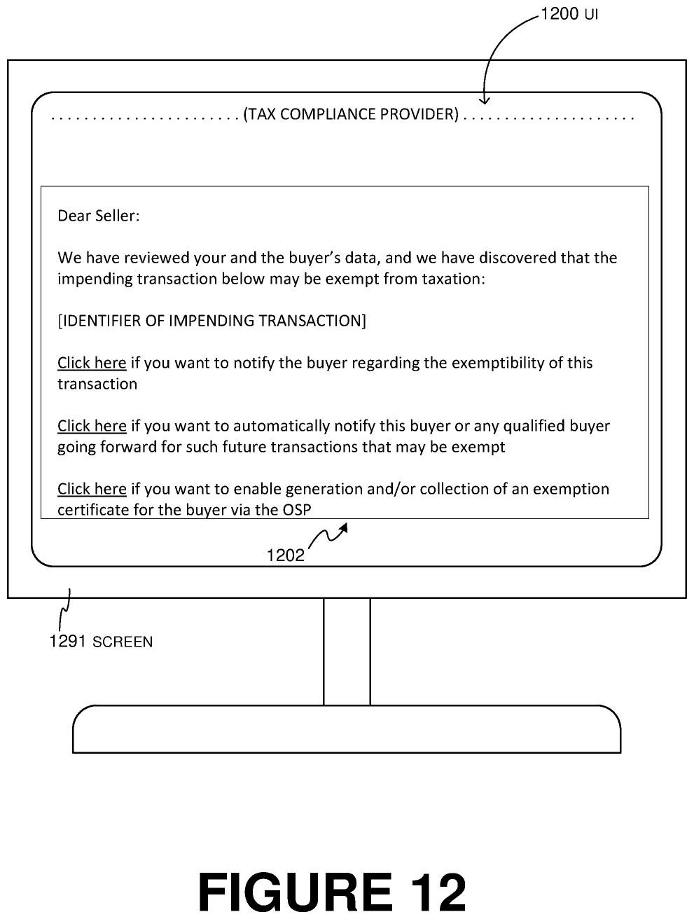

FIG. 12 is a sample view of a User Interface (UI) 1200 in which a notification 1202 is presented to a primary entity regarding the exemptibility of a relationship instance according to an example use case of an embodiment of the present disclosure, which is an improvement in automated computerized systems.

Shown is UI 1200 presented on a screen 1291 of a device. For example, the screen 1291 may be screen 1091 of the computer system 1090 or other device of the seller 1093 or user 1092 of FIG. 10. UI 1200 may comprise a portion of a UI of the OSP 1098 presented to the seller 1093 or user 1092. In various embodiments, the notification 1202 is an example of the notification 1066 of FIG. 10. In the present example, notification 1202 includes an identifier of the transaction 1097 determined to be exemptible along with options individually selectable by the user 1092 to: notify the buyer 1096 regarding the exemptibility of the transaction 1097; automatically notify the buyer 1096 or any qualified buyer going forward for such future transactions that may be exempt; and enable generation and/or collection of an exemption certificate for the buyer 1096 via the OSP 1098. In various embodiments, such notifications may be made via the OSP 1098.

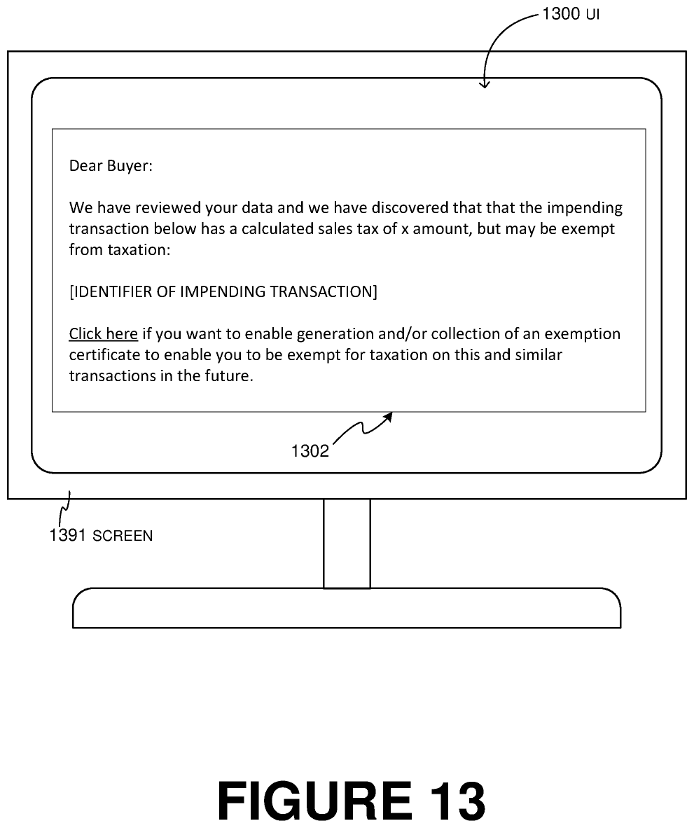

FIG. 13 is a sample view of a User Interface (UI) 1300 in which a notification is presented to a secondary entity regarding the exemptibility of a relationship instance according to an example use case of an embodiment of the present disclosure, which is an improvement in automated computerized systems.

Shown is UI 1300 presented on a screen 1391 of a device. For example, the screen 1391 may be screen 1091 of the computer system 1090 or other device of the seller 1093 or user 1092 of FIG. 10. UI 1300 may comprise a portion of a UI of the OSP 1098 presented to the buyer 1096. In various embodiments, the notification 1302 may be sent in response to the seller 1093 selecting the option shown in notification 1202 of FIG. 12 to notify the buyer 1096 regarding the exemptibility of the transaction 1097. In other embodiments, the notification 1302 is an example of the notification 1066 of FIG. 10. In the present example, notification 1302 includes an identifier of the impending transaction 1097 determined by the OSP 1098 to be exemptible along with a selectable option for the buyer 1096 to initiate generation and/or collection of an exemption certificate to enable the buyer 1096 to be exempt for taxation on transaction 1097 and similar transactions in the future.

The embodiments described above may also use synchronous or asynchronous primary entity-server computing techniques, including software as a service (SaaS) techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, primary entity-server, or peer-to-peer, running on one or more computer systems each having one or more CPUs. Some embodiments may execute concurrently and asynchronously, and further communicate using message passing techniques. Equivalent synchronous embodiments are also supported. Also, other functions could be implemented and/or performed by each component/module, and in different orders, and by different components/modules, yet still achieve the functions of the systems and methods described herein.

In addition, programming interfaces to the data stored by the systems described herein and to other system components described herein may be available by mechanisms such as through C, C++, C #, and Java APIs; libraries for accessing files, databases, or other data repositories; through scripting languages such as JavaScript and VBScript; or through Web servers, FTP servers, or other types of servers providing access to stored data. The databases described herein and other system components may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality may be provided by each component/module, or existing functionality could be distributed amongst the components/modules in different ways, yet still achieve the functions described herein.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer system including at least:
one or more processors; and
a non-transitory computer-readable storage medium having stored thereon instructions which, when executed by the one or more processors, result in operations including at least:
receiving a dataset on behalf of a primary entity, in which the dataset includes data regarding a relationship instance between the primary entity and a secondary entity;
looking up one or more alignment digital rules that determine exemptibility of the relationship instance, in which the exemptibility indicates whether or not the relationship instance is exempt from a requirement to remit a non-zero resource associated with the relationship instance;
applying the one or more alignment digital rules to the relationship instance based on one or more attributes of the relationship instance;
determining the exemptibility of the relationship instance based on the application of the one or more alignment digital rules to the relationship instance; and
transmitting a notification regarding the exemptibility of the relationship instance.

2. The system of claim 1 in which the transmitting the notification includes:
transmitting the notification to the primary entity.

3. The system of claim 1 in which the transmitting the notification includes:
transmitting the notification to the secondary entity.

4. The system of claim 1 in which the transmitting the notification includes:
enabling the primary entity to transmit the notification to the secondary entity.

5. The system of claim 1 in which the relationship instance is an impending relationship instance and the notification includes a recommendation of a possible different production of resources for the relationship instance based on the determination of the exemptibility.

6. The system of claim 1 in which the notification indicates exemptibility of one or more of: item that is a subject of the relationship instance and the secondary entity.

7. The system of claim 1 in which the relationship instance is an impending relationship instance.

8. The system of claim 1 in which the determining the exemptibility of the relationship instance is based on one or more of: an item that is a subject of the relationship instance, one or more attributes of the primary entity that is providing the item, one or more attributes of the secondary entity that is receiving the item, one or more attributes of a domain with which the relationship instance is associated, one or more attributes of a location in which the item is received, one or more locations from which the item is sent.

9. The system of claim 8 in which the item is a service provided to the secondary entity.

10. The system of claim 1 in which the applying the one or more alignment digital rules to the relationship instance includes:
parsing the dataset to obtain the one or more attributes of the relationship instance;
determining that at least one particular alignment digital rule of the one or more looked-up alignment digital rules applies to at least one corresponding attribute of the one or more attributes; and
determining whether or not the at least one corresponding attribute meets a requirement of the at least one particular alignment digital rule for the relationship instance to be exempt from the requirement to remit a non-zero resource associated with the relationship instance.

11. The system of claim 1 in which there is no known prior relationship instance between the primary entity and secondary entity in which application of the alignment digital rules indicated the prior relationship instance was exempt from a requirement to remit a non-zero resource associated with the relationship instance.

12. The system of claim 1 in which the operations further include:
prior to determining the exemptibility, presenting to a user associated with the primary entity, during on-boarding of the primary entity to an online service platform (OSP) when subscribing to services of the OSP that provide resource production for relationship instances of the primary entity, a selectable option to have the OSP determine the exemptibility of future relationship instances associated with particular attributes of previous relationship instances associated with the primary entity; and
receiving a selection of the option from the user, in which the dataset includes data regarding a previous relationship instance, the notification is based on the selection of the option, and the notification includes a notification regarding exemptibility of future relationship instances associated with one or more particular attributes of the relationship instance.

13. The system of claim 1 in which the relationship instance is an impending relationship instance and the operations further include:
looking up one or more resource digital rules for producing the non-zero resource associated with the relationship instance;
applying the one or more resource digital rules to the relationship instance based on one or more attributes of the relationship instance;
producing the non-zero resource associated with the relationship instance based on the application of the one or more resource digital rules to the relationship instance; and
transmitting a notification regarding the non-zero resource in conjunction with the notification regarding the exemptibility of the relationship instance.

14. The system of claim 1 in which the applying the one or more alignment digital rules to the relationship instance based on one or more attributes of the relationship instance includes:
looking up data regarding the secondary entity including looking up one or more of: researched content regarding one or more attributes of the relationship instance; usage data regarding one or more attributes of the relationship instance; and information accessed via a trusted remote system that validates one or more aspects regarding the secondary entity or regarding one or more attributes of the relationship instance; and
comparing the looked up data regarding the secondary entity to requirements of exemptibility indicated by the one or more alignment digital rules.

15. The system of claim 14, in which the operations further include:
determining that the secondary entity is a net new secondary entity to the primary entity in which the primary entity has not had a previous relationship instance with the secondary entity;
in response to determining that the secondary entity is a net new secondary entity to the primary entity, automatically retrieving and storing additional information regarding the secondary entity from the looked-up data regarding the secondary entity; and
using the looked-up data regarding the secondary entity to initiate a workflow to obtain exemption documents regarding the secondary entity if it was determined the relationship instance is potentially exempt from a requirement to remit a non-zero resource associated with the relationship instance.

16-45. (canceled)
